(19) United States
(12) Patent Application Publication
(10) Pub. No.: US 2009/0028390 A1
(43) Pub. Date: Jan. 29, 2009

(54) Image Processing for Estimating Subject Distance

(75) Inventor: Ikuo Hayaishi, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/178,518

(22) Filed: Jul. 23, 2008

(30) Foreign Application Priority Data
Jul. 24, 2007 (JP) 2007-192459

(51) Int. Cl. G06K 9/00

(52) U.S. Cl. 382/106

(57) ABSTRACT

An image processing method includes acquiring first information that indicates a size of an image of a specific subject in a target image relative to a size of the target image, acquiring second information that indicates a size of the specific subject, acquiring third information with which an angle of view of the target image can be determined, and estimating a subject distance, which is a distance from an image pickup apparatus that has generated the target image to the specific subject on the basis of the first information, the second information and the third information.

### CROSS-REFERENCE TO RELATED APPLICATIONS

This application claims the benefit of priority under 35 USC 119 in Japanese application no. 2007-192459, filed on Jul. 24, 2007, which application is incorporated by reference in its entirety.

### BACKGROUND

1. Technical Field

The invention relates to an image processing technology for estimating a subject distance.

2. Related Art

An image processing technology for deforming a digital image has been known and is described, for example, in JP-A-2004-318204. JP-A-2004-318204 describes an image processing that deforms the shape of a face in such a manner that part of an area on the image of a face (the area that shows the image of a cheek, for example) is set as a correction area. The correction area is divided into a plurality of small areas in accordance with a predetermined pattern, and the image is enlarged or reduced with a scaling factor set for each small area.

Incidentally, the impression obtained by observing an image of a face that is generated through imaging using an image pickup apparatus (for example, a digital still camera) changes in accordance with the distance (hereinafter, referred to as “subject distance”) from the image pickup apparatus to the face (subject) at the time of imaging. Thus, the image processing that deforms the shape of a face is preferably executed in a mode based on a subject distance. However, a method of estimating the subject distance of an image has not been known.

This problem is not limited to a case in which the subject is a face, but also applies to other subjects.

### SUMMARY

The invention provides a technology for estimating the subject distance of an image. The invention may be implemented as the following aspects or application examples.

### FIRST APPLICATION EXAMPLE

One aspect of the invention provides an image processing method that includes acquiring first information that indicates a size of an image of a specific subject in a target image relative to a size of the target image, acquiring second information that indicates a size of the specific subject, acquiring third information with which an angle of view of the target image can be determined, and estimating a subject distance, which is a distance from an image pickup apparatus that has generated the target image to the specific subject on the basis of the first information, the second information and the third information.

According to the above image processing method, the size of the subject may be estimated in view of the entire target image on the basis of the first information and the second information. In addition, the subject distance of the target image may be estimated on the basis of the estimated size of the subject in view of the entire target image and the third information.

### SECOND APPLICATION EXAMPLE

In the image processing method according to the first application example, the image processing method may further include executing a specific process using the estimated subject distance.

According to the above image processing method, the specific process may be executed using the estimated subject distance.

### THIRD APPLICATION EXAMPLE

In the image processing method according to the second application example, the execution of the specific process may include, as the specific process, executing image deformation within an area that includes the specific subject in the target image, and setting a deformation degree for the image deformation on the basis of the estimated subject distance so as to increase the deformation degree when the subject distance is small.

According to the above image processing method, the image may be appropriately deformed in conformity to the estimated subject distance, so that it is possible to appropriately approximate the impression of the subject obtained by observing the image to the impression obtained by observing the actual subject.

### FOURTH APPLICATION EXAMPLE

In the image processing method according to the second application example, the execution of the specific process may include, as the specific process, executing a blurring process on an image in a predetermined background area in the target image, and setting a blurring degree in the blurring process on the basis of the estimated subject distance so as to increase the blurring degree when the subject distance is small.

In the above image processing method, the blurring process may be executed on the image in conformity to the estimated subject distance, so that it is possible to implement a natural, favorable image blurring process that is adapted to the characteristic of the image pickup apparatus.

### FIFTH APPLICATION EXAMPLE

In the image processing method according to the second application example, the execution of the specific process may include, as the specific process, generating an image file that contains data indicating an image that includes the specific subject and data indicating the estimated subject distance.

According to the above image processing method, it is possible to generate the image file that contains the data indicating the image that includes the specific subject and the data indicating the estimated subject distance.

### SIXTH APPLICATION EXAMPLE

In the image processing method according to the second application example, the image processing method may further include generating an image through imaging, wherein the execution of the specific process may include, as the specific process, setting a range, within which a focal point should be placed at the time of imaging of the specific subject in the generation of the image, to a range that is narrower than a maximum range, within which the focal point can be placed, on the basis of the estimated subject distance.

According to the above image processing method, it is possible to reduce time required for focusing.

### SEVENTH APPLICATION EXAMPLE

In the image processing method according to the second application example, the image processing method may further include generating an image through imaging, wherein the execution of the specific process may include, as the specific process, determining an imaging timing of the specific subject in the generation of the image on the basis of the estimated subject distance.

In the above image processing method, it is possible to generate an image by determining the imaging timing in connection with the subject distance.

### EIGHTH APPLICATION EXAMPLE

In the image processing method according to the first application example, the image processing method may further include a subject detection unit that detects the image of the specific subject in the target image.

In the above image processing method, it is possible to estimate a subject distance for the specific subject that is detected from the target image.

### NINTH APPLICATION EXAMPLE

In the image processing method according to the first application example, the specific subject may be a face of a person.

In the above image processing method, it is possible to estimate a subject distance for the face of a person as a subject.

### TENTH APPLICATION EXAMPLE

In the image processing method according to the first application example, the third information may be information by which a relationship between the focal length of a lens at the time of imaging and the size of an imaging plane is determined.

The aspects of the invention may be implemented in various forms. For example, it may be implemented in a form, such as an image processing method and device, an image deformation method and device, an image generating method and device, a printing method and device, a computer program for implementing the functions of these methods or devices, a recording medium that contains the computer program, data signals that are realized in carrier waves that contain the computer program, and the like.

### BRIEF DESCRIPTION OF THE DRAWINGS

The invention will be described with reference to the accompanying drawings, wherein like numbers reference like elements.

FIG. 1 is a view that schematically illustrates the configuration of a printer, which serves as an image processing device, according to a first example embodiment of the invention.

FIG. 2 is a view that illustrates one example of a user interface that includes the list display of images.

FIG. 3 is a flowchart of a face shape correction printing process that is performed by the printer according to the present example embodiment.

FIG. 4 is a flowchart of a face shape correction process according to the present example embodiment.

FIG. 5 is a view that illustrates one example of a user interface for setting the type and degree of image deformation.

FIG. 6 is a view that illustrates one example of the detection result of a face area.

FIG. 7 is a view that illustrates the setting result of a deformation area in step S500.

FIG. 8 is a view that illustrates a method of estimating a subject distance.

FIG. 9A and FIG. 9B are views illustrating a result after a deformation process has been performed.

FIG. 10 is a view that illustrates a difference in impression of a subject.

FIG. 11 is a graph that shows the relationship between a distance and a ratio of a second width to a first width.

FIG. 12A is a graph that shows the relationship between a deformation quantity and a subject distance, and FIG. 12B is a graph that shows the relationship between a ratio Rw and the subject distance.

FIG. 13 is a view that illustrates one example of the state of a display unit on which a target image obtained after face shape correction is displayed.

FIG. 14 is a view that illustrates one example of the detection result of a face area.

FIG. 15 is a flowchart of a deformation area setting process.

FIG. 16 is a flowchart of a position adjustment process in which the position of the face area in the height direction is adjusted.

FIG. 17 is a view that illustrates one example of a specific area.

FIG. 18 is a view that illustrates one example of a method of calculating evaluation values.

FIG. 19A and FIG. 19B are views, each of which illustrates one example of a method of selecting evaluation target pixels.

FIG. 20 is a view that illustrates one example of a method of determining a height reference point.

FIG. 21 is a view that illustrates one example of a method of calculating an approximate inclination angle.

FIG. 22 is a view that illustrates one example of a method of adjusting the position of the face area in a height direction.

FIG. 23 is a flowchart of an inclination adjustment process in which the inclination of the face area is adjusted in the first example embodiment.

FIG. 24 is a view that illustrates one example of a method of calculating evaluation values used for adjusting the inclination of the face area.

FIG. 25 is a view that illustrates one example of the calculation result of a variance of evaluation values with respect to each evaluation direction.

FIG. 26 is a view that illustrates one example of a method of adjusting the inclination of the face area.

FIG. 27 is a view that illustrates one example of a method of setting a deformation area.

FIG. 28 is a flowchart of the deformation process.

FIG. 29 is a view that illustrates one example of a method of dividing the deformation area into small areas.

FIG. 30 is a view that illustrates one example of the content of a dividing point moving table.

FIG. 31 is a view that illustrates one example of movement of positions of dividing points in accordance with the dividing point moving table.

FIG. 32 is a view that illustrates the concept of a method of performing deformation on an image using a divided area deformation unit.

FIG. 33 is a view that illustrates the concept of a method of performing deformation process on an image in a triangle area.

FIG. 34 is a view that illustrates a mode of face shape correction.

FIG. 35A and FIG. 35B are schematic views, each of which shows another example embodiment of a deformation process.

FIG. 36 is a view that schematically illustrates the configuration of a printer, which serves as an image processing device, according to a second example embodiment of the invention.

FIG. 37 is a flowchart of a background blur printing process performed by the printer according to the second example embodiment.

FIG. 38 is a view that illustrates one example of a target image of the background blur printing process.

FIG. 39 is a graph that shows the relationship between a blurring degree and a subject distance.

FIG. 40A and FIG. 40B are views, each of which illustrates one example of the target image on which a blurring process has been executed.

FIG. 41 is a view that schematically illustrates the configuration of a digital still camera, which serves as an image processing device, according to a third example embodiment of the invention.

FIG. 42 is a flowchart of an image generating process executed by the DSC according to the third example embodiment.

FIG. 43 is a view that schematically illustrates the image generating process according to the third example embodiment.

### DESCRIPTION OF EXEMPLARY EMBODIMENTS

The invention is now described in the following order on the basis of example embodiments.
A. First Example Embodiment
A-1. Configuration of Image Processing Device
A-2. Face Shape Correction Printing Process
A-3. Setting of Deformation Area
A-4. Deformation Process
A-5. Other Deformation Process
B. Second Example Embodiment
C. Third Example Embodiment
D. Alternative Example Embodiment

### A. First Example Embodiment

### A-1. Configuration of Image Processing Device

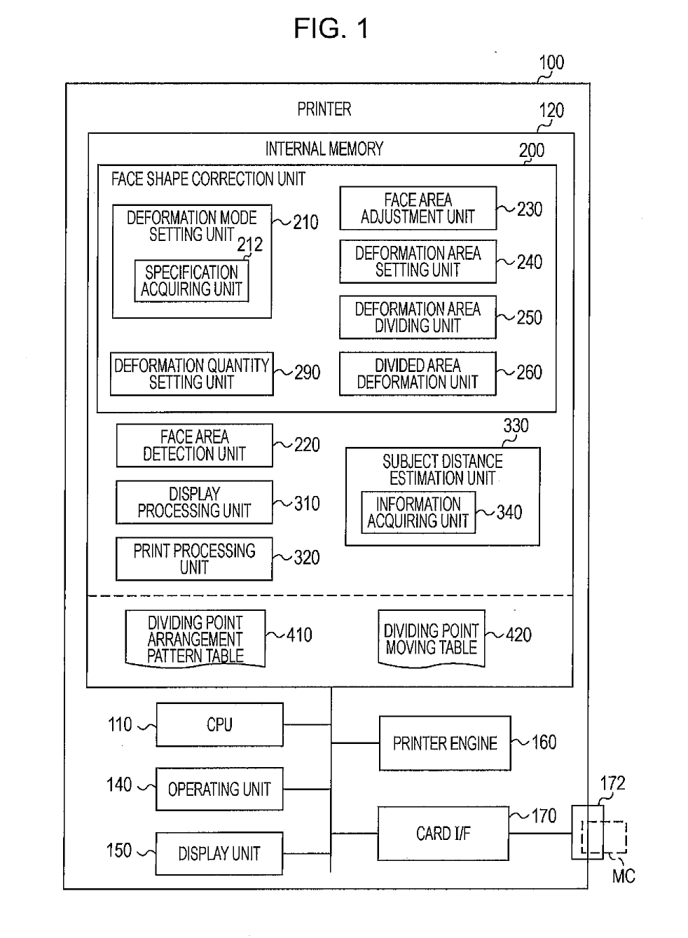

FIG. 1 is a block diagram that schematically illustrates the configuration of a printer 100, which serves as an image processing device, according to a first example embodiment of the invention. The printer 100 of the first example embodiment is a color ink jet printer that is able to print out an image on the basis of image data acquired from a memory card MC, or the like, which is so-called direct print. The printer 100 includes a CPU 110, an internal memory 120, an operating unit 140, a display unit 150, a printer engine 160, and a card interface (card I/F) 170. The CPU 110 controls portions of the printer 100. The internal memory 120 is, for example, formed of ROM and/or RAM. The operating unit 140 is formed of buttons and/or a touch panel. The display unit 150 is formed of a liquid crystal display. The printer 100 may further include an interface that performs data communication with other devices (for example, a digital still camera or a personal computer). The components of the printer 100 are connected through a bus with one another.

The printer engine 160 is a printing mechanism that performs printing on the basis of print data. The card interface 170 is an interface that transmits or receives data to or from the memory card MC that is inserted in a card slot 172. In the present example embodiment, the memory card MC contains an image file that includes image data as RGB data. The image file is, for example, a file that is generated by an image pickup apparatus, such as a digital still camera, in accordance with the Exif (Exchangeable Image File Format) specification. The image file not only contains image data generated through imaging but also contains additional pieces of data, such as aperture, shutter speed, and the focal length of a lens, at the time of imaging. The printer 100 acquires the image file stored in the memory card MC through the card interface 170.

The internal memory 120 contains a face shape correction unit 200, a face area detection unit 220, a subject distance estimation unit 330, a display processing unit 310, and a print processing unit 320. The face shape correction unit 200, the face area detection unit 220 and the subject distance estimation unit 330 are computer programs that respectively execute a face shape correction process, a face area detection process and a subject distance estimation process, which will be described later, under a predetermined operating system. The display processing unit 310 is a display driver that controls the display unit 150 to display a processing menu or a message on the display unit 150. The print processing unit 320 is a computer program that generates print data using image data, controls the printer engine 160 and then executes printing of an image on the basis of the print data. The CPU 110 reads out these programs from the internal memory 120 and then executes the programs to thereby implement the functions of these units.

The face shape correction unit 200 includes, as a program module, a deformation mode setting unit 210, a face area adjustment unit 230, a deformation area setting unit 240, a deformation area dividing unit 250, a divided area deformation unit 260 and a deformation quantity setting unit 290. The deformation mode setting unit 210 includes a specification acquiring unit 212. In addition, the subject distance estimation unit 330 includes an information acquiring unit 340 as a program module. The functions of these units will be specifically described later in the description of the face shape correction printing process. As will also be described later, the deformation area dividing unit 250 and the divided area deformation unit 260 perform deformation of an image. Therefore, the deformation area dividing unit 250 and the divided area deformation unit 260 may be collectively termed as a “deformation processing unit”. In addition, the face area detection unit 220 detects the image of a face as a subject and, therefore, may be termed as a “subject detection unit”.

The internal memory 120 also contains a dividing point arrangement pattern table 410 and a dividing point moving table 420. The contents of the dividing point arrangement pattern table 410 and dividing point moving table 420 will also be specifically described later in the description of the face shape correction printing process.

### A-2. Face Shape Correction Printing Process

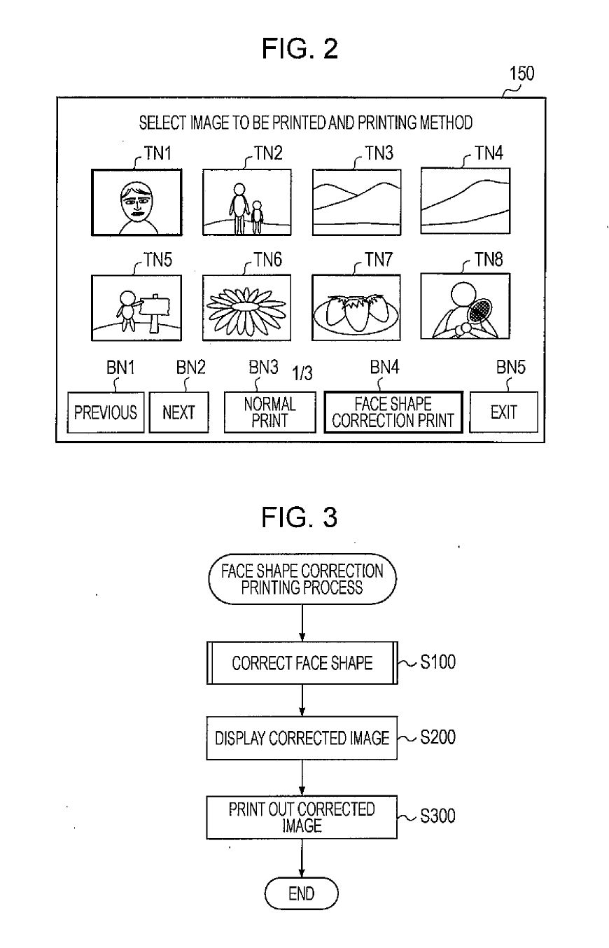

The printer 100 prints out an image on the basis of an image file stored in the memory card MC. As the memory card MC is inserted into the card slot 172, a user interface that includes the list display of images stored in the memory card MC is displayed on the display unit 150 by the display processing unit 310. FIG. 2 is a view that illustrates one example of a user interface that includes the list display of images. On the user interface shown in FIG. 2, eight thumbnail images TN1 to TN8 and five buttons BN1 to BN5 are displayed. In the present example embodiment, the list display of images is performed using thumbnail images included in the image file that is contained in the memory card MC.

When a user selects an image (or multiple images) and in addition selects a normal print button BN3 using the user interface shown in FIG. 2, the printer 100 executes a normal printing process and prints out the selected image as usual. On the other hand, when a user selects an image (or multiple images) and in addition selects a face shape correction print button BN4 using the user interface, the printer 100 executes a face shape correction printing process on the selected image, in which the printer 100 corrects the shape of a face in the image and then prints out the corrected image. In the example shown in FIG. 2, the thumbnail image TN1 and the face shape correction print button BN4 are being selected. Thus, the printer 100 performs a face shape correction printing process on an image corresponding to the thumbnail image TN1.

FIG. 3 is a flowchart of a face shape correction printing process performed by the printer 100 according to the first example embodiment. In step S100, the face shape correction unit 200 (FIG. 1) executes a face shape correction process in which at least part of the shape of a face (for example, the shape of the contour of a face and the shape of eyes) in the image is corrected. Note that parts of the face, such as eyes or a nose, are generally called organs as well.

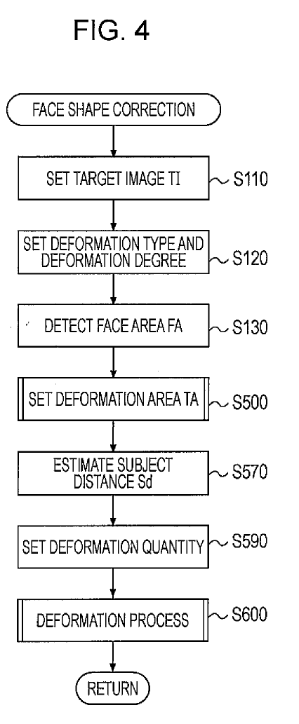

FIG. 4 is a flowchart of the face shape correction process (step S100 in FIG. 3) according to the first example embodiment. In step S110, the face shape correction unit 200 (FIG. 1) sets a target image TI on which the face shape correction process is executed. The face shape correction unit 200 sets the image corresponding to the thumbnail image TN1, which is selected by a user through the user interface shown in FIG. 2, as the target image. The image file of the set target image TI is acquired by the printer 100 from the memory card MC through the card interface 170 and is stored in a predetermined area of the internal memory 120. The image data that is contained in the image file, which is acquired from the memory card MC and stored in the internal memory 120 of the printer 100 as described above, is also termed “original image data”. In addition, the image represented by the original image data is also termed “original image”.

In step S120 (FIG. 4), the deformation mode setting unit 210 (FIG. 1) sets the type of image deformation and the degree of image deformation for face shape correction. The deformation mode setting unit 210 instructs the display processing unit 310 to display a user interface, with which the type and degree of image deformation are set, on the display unit 150, selects the type and degree of image deformation that are specified by the user through the user interface, and then sets the type and degree of image deformation used for processing.

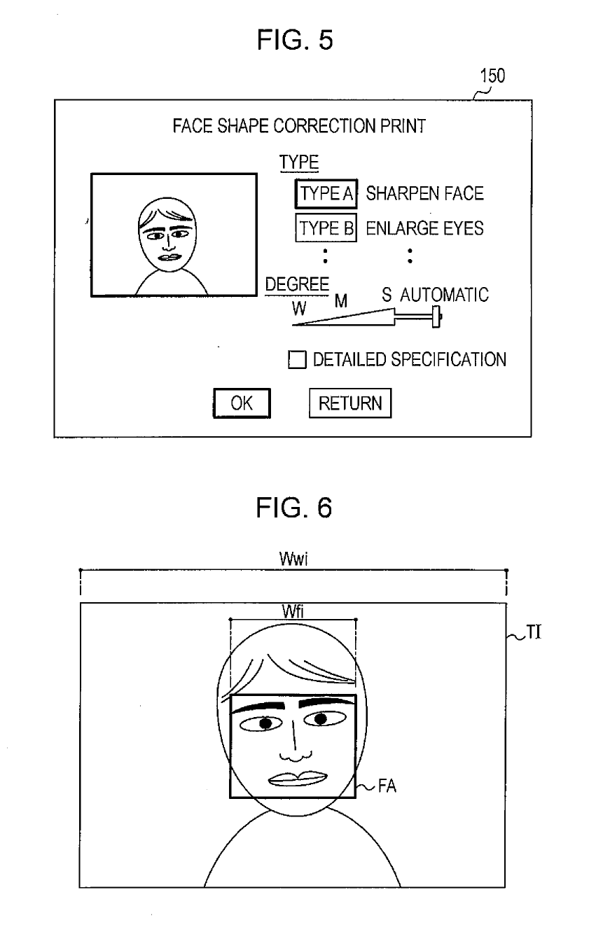

FIG. 5 is a view that illustrates one example of a user interface for setting the type and degree of image deformation. As shown in FIG. 5, this user interface includes an interface for setting the type of image deformation. In the present example embodiment, for example, a deformation type “type A” in which the shape of a face is sharpened, a deformation type “type B” in which the shape of eyes is enlarged, and the like, are set in advance as choices. The user specifies the type of image deformation using this interface. The deformation mode setting unit 210 sets the image deformation type, which is specified by the user, as an image deformation type used for the actual process.

In addition, the user interface shown in FIG. 5 includes an interface for setting the degree (extent) of image deformation. As shown in FIG. 5, in the present example embodiment, the degree of image deformation is set in advance from four choices of three steps Strong (S), Middle (M) and Weak (W), and Automatic. The user specifies the degree of image deformation using this interface. When any one of the three choices, Strong, Middle, and Weak is specified, the deformation mode setting unit 210 sets the specified degree of image deformation as the degree of image deformation used for actual process. When “Automatic” is specified, the degree of image deformation (deformation quantity) is automatically set by the deformation quantity setting unit 290 (FIG. 1). The checkbox provided on the user interface is checked when a user desires to specify the deformation mode in detail.

In the following description, it is assumed that the deformation type “type A” in which the shape of a face is sharpened is set as the type of image deformation, the degree “Automatic” is set as the degree of image deformation, and a detailed specification is not desired by the user.

In step S130 (FIG. 4), the face area detection unit 220 (FIG. 1) detects a face area FA in the target image TI. Here, the face area FA means an image area on the target image TI and an area that includes at least part of an image of a face. The detection of the face area FA by the face area detection unit 220 is executed by means of a known face detection method, such as a method through pattern matching using, for example, templates (refer to JP-A-2004-318204).

FIG. 6 is a view that illustrates one example of the detection result of the face area FA. In the example shown in FIG. 6, the face image of a person is included in a target image TI. Therefore, in step S130, a face area FA is detected from the target image TI. As shown in FIG. 6, the face area FA is a rectangular area that includes the images of eyes, a nose and a mouth on the target image TI. The face area detection unit 220, as a result of detection of the face area FA, outputs information (for example, the coordinates of four vertexes of the face area FA) that can specify the position of the face area FA in the target image TI. In addition, as shown in FIG. 6, in the present example embodiment, the width of the target image TI is represented by Wwi (unit: the number of pixels) and the width of the face area FA is represented by Wfi (unit: the number of pixels).

In the detection of the face area FA in step S130, when no face area FA is detected, the user is notified to that effect through the display unit 150. In this case, normal printing that does not accompany face shape correction may be performed or a detection process to detect the face area FA may be performed again using another face detection method.

In step S130, a face area FA is detected from the target image TI through pattern matching using templates. The known face detection method, such as a method through pattern matching using templates, generally does not minutely detect the position or inclination (angle) of the entire face or portions of a face (eyes, a mouth, or the like) but sets an area in the target image TI, in which it may be regarded that the image of a face is substantially included, as the face area FA.

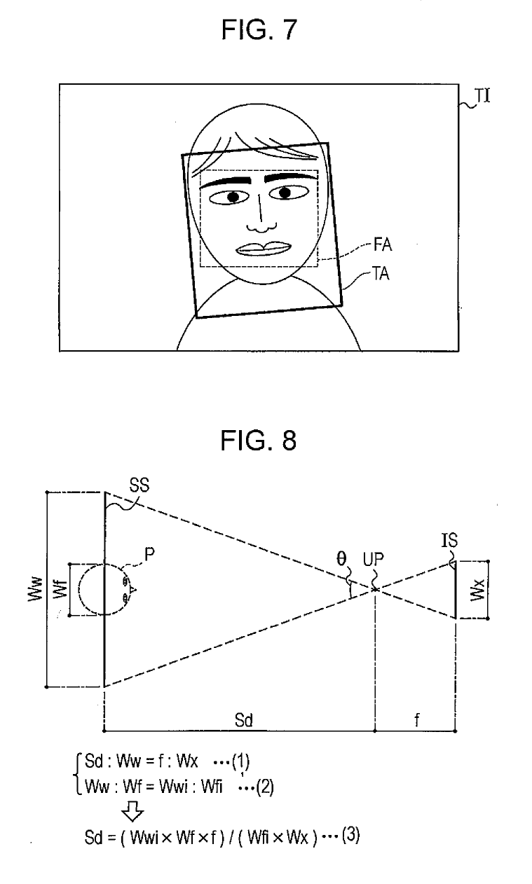

In step S500 (FIG. 4), the printer 100 sets a deformation area TA on the basis of the detected face area FA. The deformation area TA is an area on the target image TI and is an area on which image deformation processing is performed for face shape correction. The method of setting a deformation area will be described later in detail in the description of “A-3. Setting of Deformation Area”. FIG. 7 is a view that illustrates the result of setting of the deformation area TA in step S500. The broken line in FIG. 7 indicates the face area FA that is detected in step S130. The wide line in FIG. 7 indicates the set deformation area TA.

In step S570 (FIG. 4), the subject distance estimation unit 330 (FIG. 1) estimates the subject distance Sd. Here, the subject distance Sd means a distance from the image pickup apparatus (more specifically, the principal point of the lens of the image pickup apparatus) to a specific subject at the time of imaging of the target image TI. In the present example embodiment, the face of a person is set as the specific subject. Thus, the subject distance Sd in the present example embodiment is a distance from the image pickup apparatus to the face of a person.

FIG. 8 is a view that illustrates a method of estimating the subject distance Sd. FIG. 8 shows the positional relationship between an imaging plane IS of the image pickup apparatus and the face of a person P, which serves as a subject, at the time of imaging of the target image TI. As shown in FIG. 8, the subject distance Sd, which is a distance between the principal point UP of the lens and the face of the person P, is determined on the basis of both the width Ww and the angle of view θ of an image pickup range on a plane (hereinafter, also referred to as “subject plane”) parallel to the imaging plane IS that includes the position of the face of the person P. In addition, the angle of view θ is determined on the basis of the relationship between the focal length f of the lens and the width Wx of the imaging plane IS. That is, the following Equation (1) holds true.

Sd:Ww=f:Wx (1)

In addition, the width Ww of the image pickup range on the subject plane SS is determined on the basis of an area that is occupied by the image of the face of the person P in the target image TI (FIG. 6). That is, it may be regarded that the ratio of the width Ww to the width Wf of the face of the person P on the subject plane SS is equal to the ratio of the width Wwi of the entire image and the width Wfi of the face area FA in the target image TI (see Equation (2)).

Ww:Wf=Wwi:Wfi (2)

From the above Equation (1) and Equation (2), the following Equation (3) is derived.

Sd=(Wwi×Wf×f)/(Wfi×Wx) (3)

The information acquiring unit 340 (FIG. 1) of the subject distance estimation unit 330 acquires information that is necessary to calculate the subject distance Sd using Equation (3). Specifically, the information acquiring unit 340 acquires the value (number of pixels) of the overall width Wwi of the target image TI that is added, as metadata, to the image file that represents the target image TI, and calculates the value (number of pixels) of the width Wfi of the face area FA (FIG. 6). The width Wfi of the face area FA is, for example, calculated by calculating a distance between two vertexes of the face area FA using the coordinates of the two vertexes. In the present example embodiment, the value of the overall width Wwi of the target image TI and the value of the width Wfi of the face area FA are pieces of information that indicate the size of the image of a face to the size of the target image TI, and may be regarded as first information according to the aspects of the invention.

The information acquiring unit 340 also acquires, as a value of the width Wf of the face of the person P, a schematic value (for example, 200 mm) of the width (the actual size of the face) of an example person that is set in advance and stored in the internal memory 120 (FIG. 1). The value of the width Wf of the face of the person P may be regarded as second information according to the aspects of the invention.

Furthermore, the information acquiring unit 340 acquires the value of the focal length f of the lens at the time of imaging, which is contained in additive data of the image file of the target image TI. Here, the acquired value of the focal length f of the lens is a 35 mm film equivalent, and may differ from the actual focal length of the image pickup apparatus. In this case, the information acquiring unit 340 acquires the preset value (=36 mm) of width of a 35 mm film as the width Wx of the imaging plane IS. Note that, when the additive data of the image file contain the data indicating the actual focal length and the data indicating the width of the image pickup device of the image pickup apparatus, the information acquiring unit 340 may acquire the value of the actual focal length as the focal length f of the lens and may acquire the value of the width of the image pickup device as the width Wx of the imaging plane IS. In addition, when the additive data of the image file contain the data that directly indicate an angle of view, the information acquiring unit 340 may acquire the data that indicate the angle of view. In the present example embodiment, the value of the focal length f of the lens and the value of the width Wx of the imaging plane IS are pieces of information, that can determine the angle of view θ of the target image TI, and may be regarded as third information according to the aspects of the invention.

The subject distance estimation unit 330 uses various pieces of information (the value of the overall width Wwi of the target image Ti, the value of the width Wfi of the face area FA, the value of the width Wf of the face of the person P, the value of the focal length f of the lens, and the value of the width Wx of the imaging plane IS), acquired by the information acquiring unit 340, and the above Equation (3) to calculate (estimate) the subject distance Sd.

In step S590 of FIG. 4, the deformation quantity setting unit 290 (FIG. 1) sets a deformation quantity (also referred to as “deformation degree” or “deformation extent”). The method of setting a deformation quantity using the deformation quantity setting unit 290 will be specifically described later in “A-4. Deformation Process”.

In step S600 (FIG. 4), the deformation process is executed on the deformation area (TA) that has been set in step S500. The specific content of the deformation process will be described in detail later in “A-4. Deformation Process”.

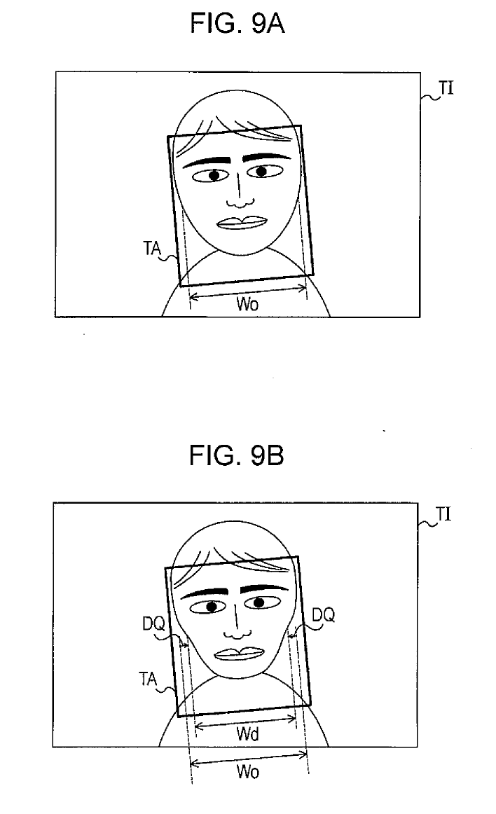

FIG. 9A and FIG. 9B are views, each of which illustrates the result after the deformation process has been performed. FIG. 9A is a view that shows the target image TI on which the deformation process is not performed in step S600 of FIG. 4. FIG. 9B is a view that shows the target image TI on which the deformation process has been performed. In the target image TI, shown in FIG. 9B, on which the deformation process has been performed, the image of the face of the person in the deformation area TA is narrowed. Note that the deformation process in step. S600 is performed only on the image within the deformation area TA in the target image TI and is not performed on the image outside the deformation area TA. As a result, it is possible to deform the subject without excessively deforming the entire image.

In the example shown in FIG. 9A and FIG. 9B, the lines of the right and left cheeks of the face (contour of the face) are moved inwardly by the deformation quantity DQ. This deformation quantity DQ is set in step S590 of FIG. 4. Through the above deformation, the width Wd of the deformed face image is narrowed twice the deformation quantity DQ in comparison with the width Wo of the face image that has not yet deformed. The reason why the image is deformed so that the width is narrowed in this way is to approximate the impression of the subject obtained by observing the image to the impression obtained by observing the actual subject.

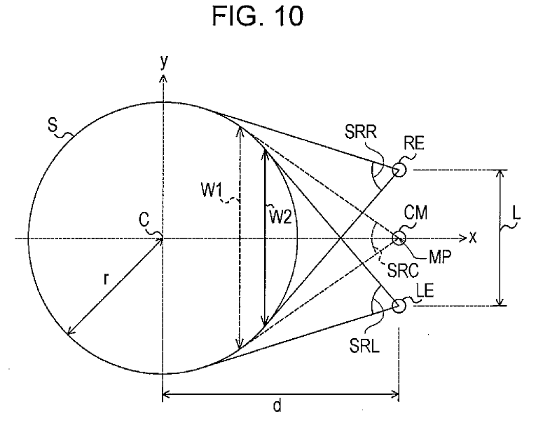

FIG. 10 is a view that illustrates a difference in impression of a subject. In FIG. 10, a subject S, the right eye RE and left eye LE of a person (observer) and a camera CM, which serves as the image pickup apparatus, are shown. FIG. 10 shows the positional relationship as viewed from the upper side of the observer.

In the example of FIG. 10, for easy description, it is assumed that the shape of the subject S as viewed from the upper side is a circle having a radius r. A circular subject S is not limited to the head of a person but may be various subjects (for example, a cylindrical building or a ball). This subject S is located in front of two eyes RE and LE. In addition, the camera CM is arranged at the middle point MP of two eyes RE and LE. That is, the camera CM views the subject S from substantially the same position as the observer. The x-axis in the drawing is a coordinate axis that extends through the center C of the subject S and the middle point MP. The y-axis is a coordinate axis that extends through the center C and is perpendicular to the x-axis. Two eyes RE and LE are aligned in the direction of the y-axis. The distance L indicates a distance between the two eyes RE and LE. In addition, the distance d indicates a distance between the center C and the eyes RE and LE along the x-axis.

The first width W1 in FIG. 10 indicates the width of the subject S. This first width W1 indicates the width of a portion that is viewable from the camera CM. The portion that is viewable from the camera CM is a portion in a camera subject range SRC on the surface of the subject S. This camera subject range SRC indicates a range in which the subject S occupies within the entire range of visual field of the camera CM.

The second width W2 in FIG. 10 also shows the width of the subject S. However, this second width W2 indicates the width of a portion that is viewable from both eyes RE and LE. The portion viewable from both eyes RE and LE is a portion of the range in which the right subject range SRR and the left subject range SRL overlap each other on the surface of the subject S. The right subject range SRR indicates a range that the subject S occupies within the entire range of visual field of the right eye RE, and the left subject range SRL indicates a range that the subject S occupies within the entire range of visual field of the left eye LE.

As shown in FIG. 10, a viewable portion of the subject S differs between the right eye RE and the left eye LE. That is, a portion viewable from the right eye RE is deviated to the right eye RE side, and a portion viewable from the left eye LE is deviated to the left eye LE side. It may be presumed that recognition of the subject S by a person (observer) is strongly influenced from a visible portion that is common to both eyes RE and LE. For example, a person may recognize the width W2 of a visible portion that is common to both eyes RE and LE as the width of the subject S.

As shown in FIG. 10, the second width W2 is narrower than the first width W1. That is, when the image generated through imaging is observed, a person receives an impression that the width is wide in comparison with the width when the actual subject S is observed. By deforming the image so as to narrow the width as shown in FIG. 9B, it is possible to approximate the impression of the subject obtained by observing the image to the impression obtained by observing the actual subject.

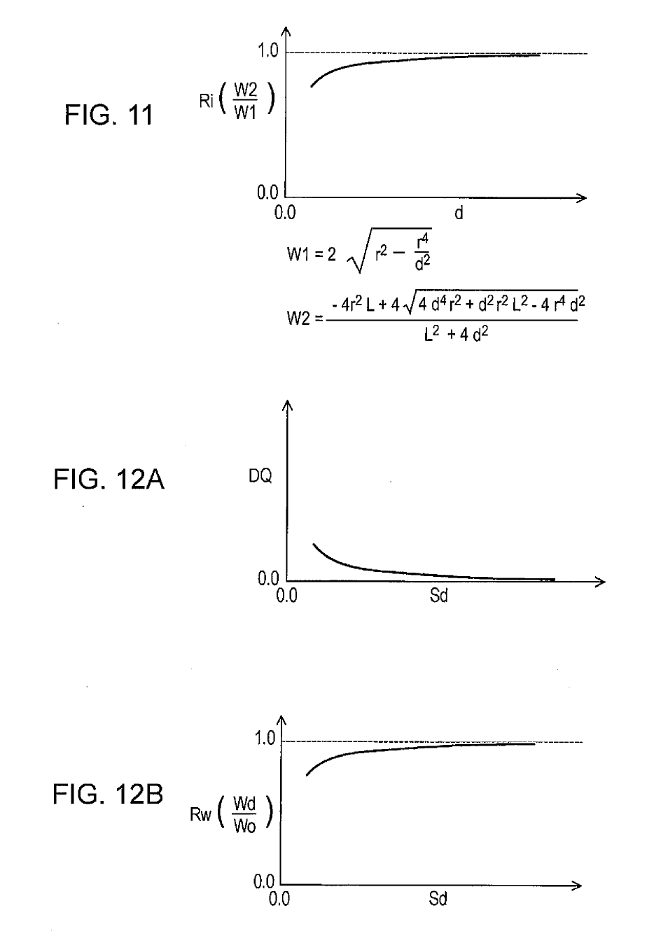

FIG. 11 is a graph that shows the relationship between the distance d and a ratio Ri of the second width W2 to the first width W1. The abscissa axis represents the distance d, and the ordinate axis represents the ratio Ri. In addition, FIG. 11 also shows the functions that represent widths W1 and W2. Widths W1 and W2 are expressed by the functions of radius r, distance d and distance L. In the graph of FIG. 11, the radius r and the distance L are fixed.

As shown in FIG. 11, the ratio Ri (W2/W1) decreases as the distance d decreases. In addition, the ratio Ri (W2/W1) is smaller than “1.0” and is approximated to “1.0” as the distance d increases.

FIG. 12A is a graph that shows the relationship between the deformation quantity DQ and the subject distance Sd. FIG. 12B is a graph that shows the relationship between the subject distance Sd and the ratio Rw of the width Wd after deformation to the width Wo before deformation. In these graphs, the abscissa axis represents the subject distance Sd that is estimated in step S570 (FIG. 4).

The deformation quantity DQ shown in FIG. 12A is set in advance so that the ratio Rw shown in FIG. 12B is equal to the ratio Ri shown in FIG. 11. As a result, the deformation quantity DQ is set to a larger value as the subject distance Sd is reduced. Here, the distance L and the radius r are fixed to a predetermined value in advance. The distance L between the eyes may be set as, for example, 100 mm. In addition, the radius r, that is, the size of the subject S may be set as a value (for example, 100 mm) that represents the subject. The deformation quantity DQ indicates the rate of change (in this case, the rate of reduction) in width in the deformation area TA.

In S590 of FIG. 4, the deformation quantity setting unit 290 (FIG. 1) uses a correspondence relationship that is set in advance as shown in FIG. 12A and, in step S570, determines the deformation quantity DQ on the basis of the calculated (estimated) subject distance Sd. In step S600 of FIG. 4, the image is deformed using the deformation quantity DQ that is determined as described above (FIG. 9B). As a result, it is possible to appropriately deform the image in conformity to the subject distance Sd. Specifically, it is possible to approximate the impression of the subject obtained by observing the image to the impression obtained by observing the actual subject.

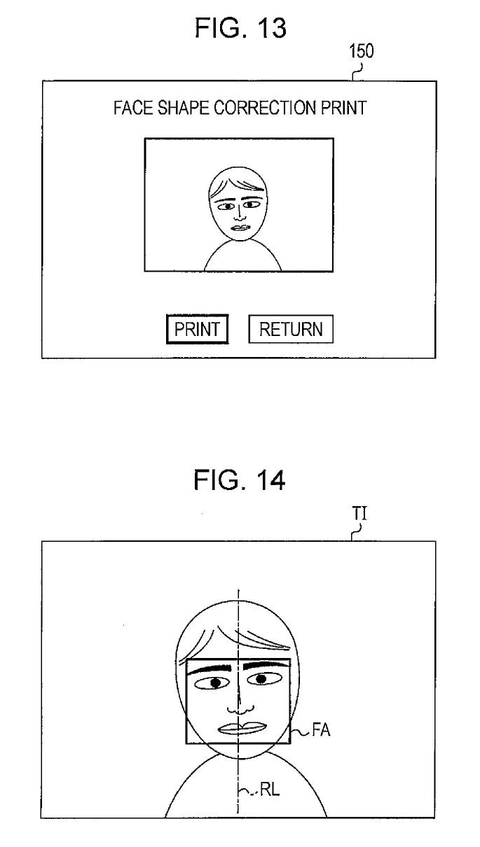

In step S200 (FIG. 3), the face shape correction unit 200 (FIG. 1) instructs the display processing unit 310 to make the display unit 150 display the target image TI on which the face shape correction has been executed. FIG. 13 is a view that illustrates one example of the state of the display unit 150 on which the target image TI obtained after face shape correction is displayed. Using the display unit 150 on which the target image TI, on which the face shape correction has been executed, is displayed, a user is able to confirm the result of the correction. When the user is not satisfied with the correction result and then selects “GO BACK” button, for example, the screen to select a deformation type and a deformation degree, shown in FIG. 5, is displayed on the display unit 150. Then, resetting of the deformation type and the deformation degree is performed by the user. When the user is satisfied with the correction result and then selects “PRINT” button, the following corrected image printing process is initiated.

In step S300 (FIG. 3), the print processing unit 320 (FIG. 1) controls the printer engine 160 to print out the target image TI on which the face shape correction process has been executed. The print processing unit 320 executes a process, such as a resolution conversion or a halftone process, on the image data of the target image on which the face shape correction process has been executed to generate print data. The generated print data is supplied from the print processing unit 320 to the printer engine 160, and the printer engine 160 prints out the target image. In this manner, printing of the target image TI, on which the face shape correction has been executed, is completed.

As described above, the printer 100 according to the present example embodiment is able to estimate the subject distance Sd in the target image TI through Equation (3) using the value of the overall width Wwi of the target image TI, the value of the width Wfi of the face area FA, the value of the width Wf of the face of the person P, the value of the focal length f of the lens and the value of the width Wx of the imaging plane IS.

In addition, in the printer 100 according to the present example embodiment, the deformation degree (deformation quantity) used in image deformation is set so as to increase the deformation degree (increase the deformation quantity) as the subject distance Sd decreases on the basis of the estimated subject distance Sd, and the deformation process is performed on the image using the set deformation quantity DQ. Thus, it is possible to achieve an image deformation process in which the impression of the subject obtained by observing the image is approximated to the impression obtained by observing the actual subject.

The deformation process performed on the image in the present example embodiment may be regarded as a specific process according to the aspects of the invention, and the face shape correction unit 200 that executes the deformation process on the image in the present example embodiment may be regarded as a specific process execution unit according to the aspects of the invention.

### A-3. Setting of Deformation Area

The process of setting the deformation area TA (step S500) in the above described face shape correction process (FIG. 4) will now be specifically described. FIG. 14 is a view that illustrates one example of the result of detection of the face area FA. As shown in FIG. 14, in step S130 of FIG. 4, the face area FA is detected from the target image TI. The reference line RL shown in FIG. 14 defines the height (up and down) direction of the face area FA and indicates the center of the width (right to left) direction of the face area FA. That is, the reference line RL is a straight line that passes the center of gravity of the rectangular face area FA and is parallel to the boundary lines that extend along the height (up and down) direction of the face area FA.

The deformation area TA is set on the basis of the face area FA. As described above, a known face detection method, such as a method through pattern matching using templates, used to detect the face area FA does not minutely detect the position or inclination (angle) of the entire face or portions of a face (eyes, mouth or the like) but sets an area in the target image TI, in which it may be regarded that the image of a face is substantially included, as the face area FA. On the other hand, because generally the image of a face highly attracts viewer's attention, there is a possibility that an image on which face shape correction has been performed may be unnatural depending on the relationship in position and/or angle between the deformation area TA set on the basis of the face area FA and the image of a face. In view thereof, in the present example embodiment, in order to achieve more natural and desirable face shape correction, position adjustment and inclination adjustment described below are performed on the face area FA that has been detected in step S130.

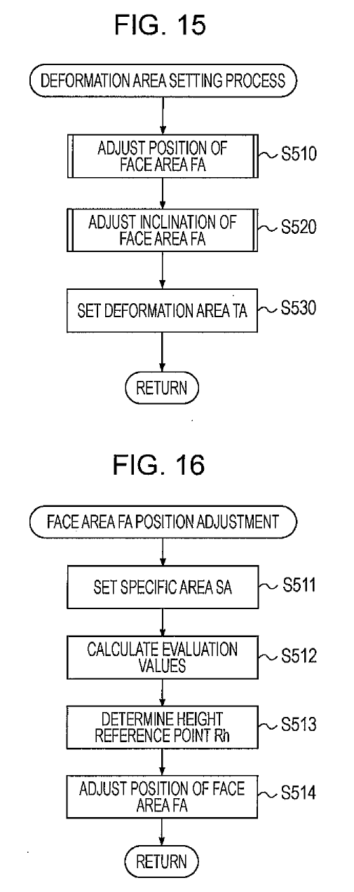

FIG. 15 is a flowchart of a deformation area setting process. In step S510, the face area adjustment unit 230 (FIG. 1) adjusts the position, in the height direction, of the face area FA that has been detected in step S130 (FIG. 4). The adjustment of position of the face area FA in the height direction means resetting the face area PA in the target image TI by adjusting the position of the face area FA along the reference line RL (see FIG. 14).

FIG. 16 is a flowchart of a position adjustment process in which the position of the face area FA in the height direction is adjusted. In step S511, the face area adjustment unit 230 (FIG. 1) sets a specific area SA. The specific area SA is an area on the target image TI that includes an image of a predetermined reference subject that is referenced when the adjustment of position of the face area FA in the height direction is executed. The reference subject may be set to “eyes”, and, in this case, the specific area SA is set to an area that includes the image of “eyes”.

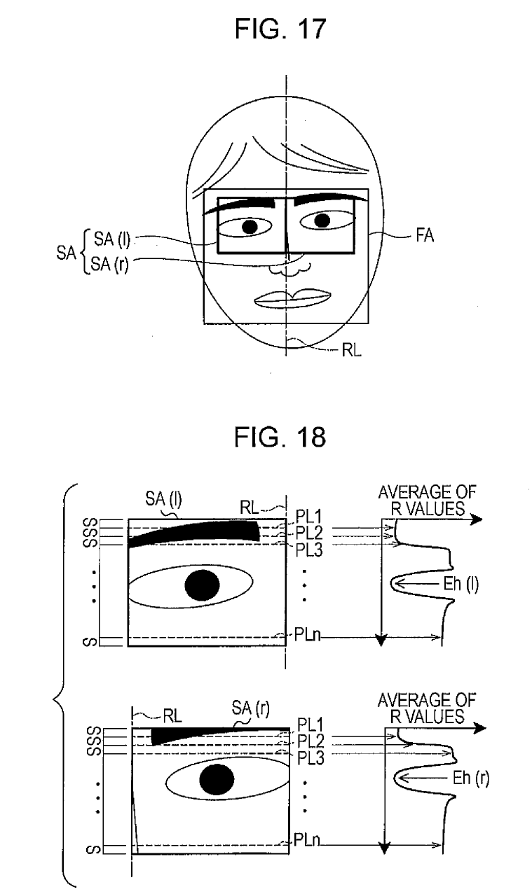

FIG. 17 is a view that illustrates one example of the specific area SA. In the present example embodiment, the face area adjustment unit 230 (FIG. 1) sets the specific area SA on the basis of the relationship with the face area FA. Specifically, the specific area SA is set as an area that is obtained by reducing (or enlarging) the size of the face area FA by a predetermined ratio in a direction perpendicular to the reference line RL and in a direction parallel to the reference line RL and that has a predetermined positional relationship with the position of the face area FA. That is, the predetermined ratio and the predetermined positional relationship are determined in advance so that, when the specific area SA is set on the basis of the relationship with the face area FA that is detected by the face area detection unit 220, the specific area SA includes the image of both eyes. The specific area SA is desirably set as an area as small as possible that includes the image of both eyes and does not include a confusing image (for example, the image of hair).

In addition, as shown in FIG. 17, the specific area SA is set to an area having a rectangular shape that is symmetrical with respect to the reference line RL. The specific area SA is divided by the reference line RL into a left side area (hereinafter, also referred to as “left divided specific area SA(l)”) and a right side area (hereinafter, also referred to as “right divided specific area SA(r)”). The specific area SA is set so that one of the eyes is included in each of the left divided specific area SA(l) and the right divided specific area SA(r).

In step S512 (FIG. 16), the face area adjustment unit 230 (FIG. 1) calculates evaluation values for detecting the position of the image of each eye in the specific area SA. FIG. 18 is a view that illustrates one example of a method of calculating evaluation values. In the present example embodiment, R values (R component values) of pixels of the target image TI, which are RGB image data, are used for calculation of the evaluation values. This is because there is a large difference in R values between, for example, the image of a portion of skin and the image of a portion of an eye and, therefore, it is possible to improve the detection accuracy of the image of an eye using R values for calculation of evaluation values. Because the data of the target image TI is acquired as RGB data, it is possible to effectively calculate evaluation values using R values. As shown in FIG. 18, calculation of evaluation values is separately performed for two divided specific areas (the right divided specific area SA(r) and the left divided specific area SA(l)).

The face area adjustment unit 230, as shown in FIG. 18, sets n straight lines (hereinafter, referred to as “target pixel specifying lines PL1 to PLn”) perpendicular to the reference line RL within the divided specific areas (the right divided specific area SA(r) and the left divided specific area SA(l)). The target pixel specifying lines PL1 to PLn are straight lines that equally divide the height (the size along the reference line RL) of each of the divided specific areas into (n+1) parts. That is, the interval between any adjacent target pixel specifying lines PL is an equal interval s.

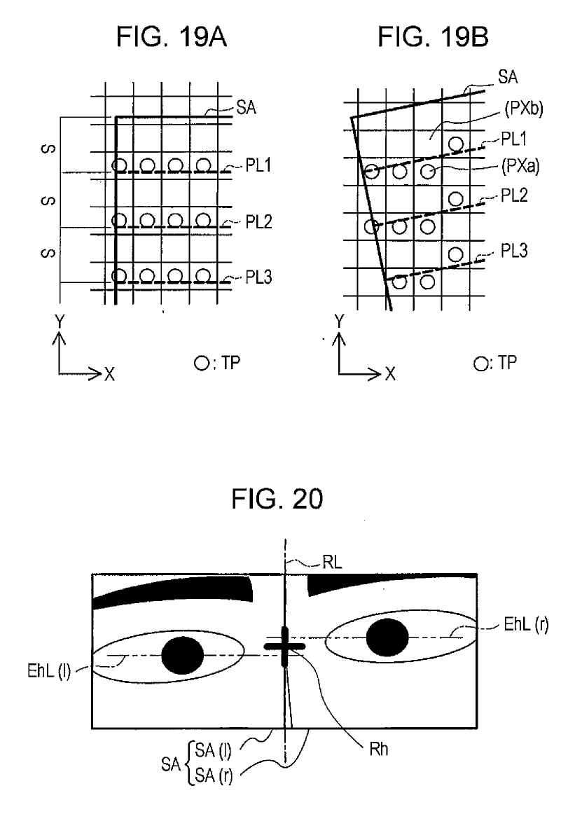

The face area adjustment unit 230 selects pixels (hereinafter, referred to as “evaluation target pixels TP”) used for calculation of evaluation values from among pixels that constitute the target image TI for each of the target pixel specifying lines PL1 to PLn. FIG. 19A and FIG. 19B are views, each of which illustrates one example of a method of selecting evaluation target pixels TP. The face area adjustment unit 230 selects the pixels that overlap each of the target pixel specifying lines PL from among the pixels that constitute the target image TI as the evaluation target pixels TP. FIG. 19A shows the case where the target pixel specifying lines PL are parallel to the row direction (X direction in FIG. 19A) of the pixels of the target image TI. In this case, the pixels arranged in each pixel row that overlaps each of the target pixel specifying lines PL (pixels to which symbol “O” is assigned in FIG. 19A) are selected as the evaluation target pixels TP with respect to each of the target pixel specifying lines PL.

On the other hand, depending on a method of detecting the face area FA or a method of setting the specific area SA, the target pixel specifying lines PL may not be parallel to the row direction (X direction) of the pixels of the target image TI, as shown in FIG. 19B. In such a case as well, as a rule, the pixels that overlap each of the target pixel specifying lines PL are selected as the evaluation target pixels TP with respect to each of the target pixel specifying lines PL. However, for example, as in the case of the relationship between a target pixel specifying line PL1 and pixels PXa and PXb, shown in FIG. 19B, when one target pixel specifying line PL overlaps two pixels arranged in the same column (that is, having the same Y coordinate) of the pixel matrix of the target image TI, one of the pixels (for example, the pixel PXb) that overlaps the target pixel specifying line PL shorter in distance than the other is excluded from the evaluation target pixel TP. That is, for each of the target pixel specifying lines PL, only one pixel is selected from one column of the pixel matrix as the evaluation target pixel TP.

When the inclination of the target pixel specifying line PL exceeds 45 degrees with respect to the X direction, the relationship between the column and row of the pixel matrix in the above description is inverted and, therefore, only one pixel is selected from one row of the pixel matrix as the evaluation target pixel TP. In addition, depending on the relationship in size between the target image TI and the specific area SA, one pixel may be selected as the evaluation target pixel TP with respect to a plurality of the target pixel specifying lines PL.

The face area adjustment unit 230 calculates the average of R values of the evaluation target pixels TP for each of the target pixel specifying lines PL. However, in the present example embodiment, with respect to each of the target pixel specifying lines PL, a portion of pixels each having a large R value within the plurality of selected evaluation target pixels TP are excluded from calculation of evaluation values. Specifically, for example, when k evaluation target pixels TP are selected with respect to one target pixel specifying line PL, the evaluation target pixels TP are separated into two groups, that is, a first group, which is composed of 0.75 k pixels each having a relatively large R value, and a second group, which is composed of 0.25 k pixels each having a relatively small R values, and then only the pixels that belong to the second group are used to calculate the average of R values as an evaluation value. The reason that a portion of evaluation target pixels TP are excluded from calculation of evaluation values will he described later.

As described above, in the present example embodiment, the evaluation value with respect to each of the target pixel specifying lines PL is calculated by the face area adjustment unit 230. Because the target pixel specifying lines PL are straight lines that are perpendicular to the reference line RL, the evaluation values may be expressed to be calculated with respect to a plurality of positions (evaluation positions) along the reference line RL. In addition, each of the evaluation values may be expressed as a value that represents the characteristics of distribution of pixel values arranged along a direction perpendicular to the reference line RL with respect to each of the evaluation positions

In step S513 (FIG. 16), the face area adjustment unit 230 (FIG. 1) detects the position of each eye in the specific area SA and then determines a height reference point Rh on the basis of the detection result. First, with respect to each of the divided specific areas, the face area adjustment unit 230, as shown on the right side in FIG. 18, creates a curve that represents a distribution of evaluation values (average of R values) along the reference line RL and then detects a position, at which the evaluation value takes a minimum value along the direction of reference line RL, as an eye position Eh. The eye position Eh in the left divided specific area SA(l) is denoted as Eh(l) and the eye position Eh in the right divided specific area SA(r) is denoted as Eh(r).

In the case of a yellow human race, it may be presumed that the portion that displays the image of skin in the divided specific area has a large R value, while on the other hand, the portion that displays the image of an eye (more specifically, the black eye portion of the center of the eye) has a small R value. Therefore, as described above, the position, at which the evaluation value (the average of R values) takes a minimum value along the reference line RL, may be determined as the eye position Eh. However, when the process is intended for other human races (such as a white race or a black race), other evaluation values (for example, luminance, lightness, B value, or the like) may be used.

As shown in FIG. 18, the divided specific area may possibly include another image (for example, the image of an eyebrow or the image of hair) having a small R value, in addition to the image of an eye. For this reason, when the curve that represents a distribution of evaluation values along the reference line RL takes multiple minimum values, the face area adjustment unit 230 determines the position that is located on the lowest side among the positions that take minimum values as the eye position Eh. Because images having small R values, such as an eyebrow or hair, are mostly located above the image of the eye, while images having small R values are rarely located below the image of the eye, the above described determination is possible.

In addition, even when the above curve is located on the lower side (mainly, a position corresponding to the image of a skin) of the image of an eye, because there is a possibility that the curve may take a minimum value despite its large evaluation value, minimum values that exceed a predetermined threshold value may be ignored. Alternatively, the position of the target pixel specifying line PL, which corresponds to a minimum value among evaluation values calculated with respect to each of the target pixel specifying lines PL, may be simply determined as the eye position Eh.

In the present example embodiment, an eye (a black eye portion of the center of the eye), which can be presumed to have a large difference in color from its surrounding face, is used as a reference subject for adjusting the position of the face area FA. However, because the average value of R values as the evaluation value is calculated for the plurality of evaluation target pixels TP on each of the target pixel specifying lines PL, the accuracy of detection of a black eye portion may be deteriorated, for example, due to the influence of an image of a white eye portion that surrounds the black eye. In the present example embodiment, as described above, the accuracy of detection of a reference subject is further improved in such a manner that a portion of evaluation target pixels TP (for example, pixels having a relatively large R value, belonging to the above described first group), which may be regarded to have a large color difference in comparison with the reference subject, are excluded from calculation of evaluation values.

Next, the face area adjustment unit 230 determines a height reference point Rh on the basis of the detected eye position Eh. FIG. 20 is a view that illustrates one example of a method of determining a height reference point Rh. The height reference point Rh is used as a reference when the position of the face area FA in the height direction is adjusted. As shown in FIG. 20, the point that is located at the middle of the positions Eh(l) and Eh(r) of the right and left eyes on the reference line RL is set as the height reference point Rh. That is, the midpoint of the intersection point of a straight line EhL(l), which indicates the left eye position Eh(l), and the reference line RL and the intersection point of a straight line EhL(r), which indicates the right eye position Eh(r), and the reference line RL is set as the height reference point Rh.

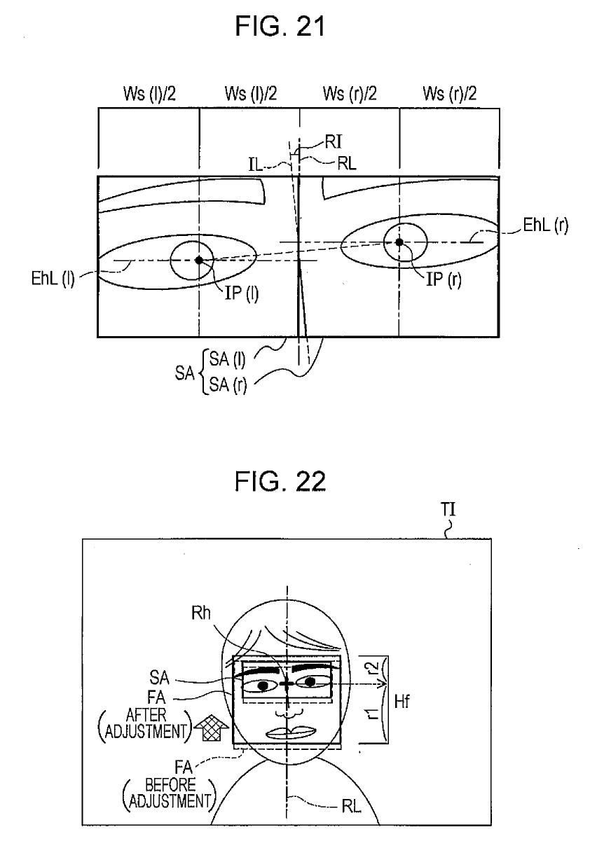

In the present example embodiment, the face area adjustment unit 230 calculates an approximate inclination angle (hereinafter, referred to as “approximate inclination angle RI”) of a face image on the basis of the detected eye position Eh. The approximate inclination angle RI of a face image is obtained by estimating how many angles at which the image of a face in the target image TI is approximately inclined with respect to the reference line RL of the face area FA. FIG. 21 is a view that illustrates one example of a method of calculating an approximate inclination angle. As shown in FIG. 21, the face area adjustment unit 230 first determines an intersection point IP(l) of a straight line, which divides the width Ws(l) of the left divided specific area SA(l) in half, and the straight line EhL(l) and an intersection point IP(r) of a straight line, which divides the width Ws(r) of the right divided specific area SA(r) in half, and the straight line EhL(r). Then, an angle that is made by a straight line IL perpendicular to the straight line that connects the intersection point IP(l) and the intersection point IP(r) with the reference line RL is calculated as the approximate inclination angle RI.

In step S514 (FIG. 16), the face area adjustment unit 230 (FIG. 1) adjusts the position of the face area FA in the height direction. FIG. 22 is a view that illustrates one example of a method of adjusting the position of the face area FA in the height direction. The adjustment of the position of the face area FA in the height direction is performed in such a manner that the face area FA is reset so that the height reference point Rh is located at a predetermined position in the face area FA of which the position has been adjusted. Specifically, as shown in FIG. 22, the position of the face area FA is adjusted upward or downward along the reference line RL so that the height reference point Rh is located at a position at which the height Hf of the face area FA is divided by a predetermined ratio of r1 to r2. In the example shown in FIG. 22, by moving the face area FA, of which the position has not yet been adjusted as shown by the dotted line, upward, the face area FA, of which the position is adjusted as shown by the solid line, is reset.

After the position of the face area FA has been adjusted, in step S520 (FIG. 15), the face area adjustment unit 230 (FIG. 1) adjusts (angle adjustment) the inclination of the face area FA. Here, the adjustment of inclination of the face area FA means resetting the face area FA so that the inclination of the face area FA in the target image TI is adjusted to conform to the inclination of the image of the face. In the present example embodiment, the predetermined reference subject that is referenced when the adjustment of inclination of the face area FA is executed is set to “both eyes”. In the adjustment of inclination of the face area FA, a plurality of evaluation directions that represent the choices of adjustment angles of inclination are set, and the evaluation specific area ESA corresponding to each of the evaluation directions is set as an area that includes the image of both eyes. Then, in regard to each of the evaluation directions, evaluation values are calculated on the basis of pixel values of the image of the evaluation specific area ESA, and then the inclination of the face area FA is adjusted using the adjustment angle of inclination determined on the basis of the evaluation values.

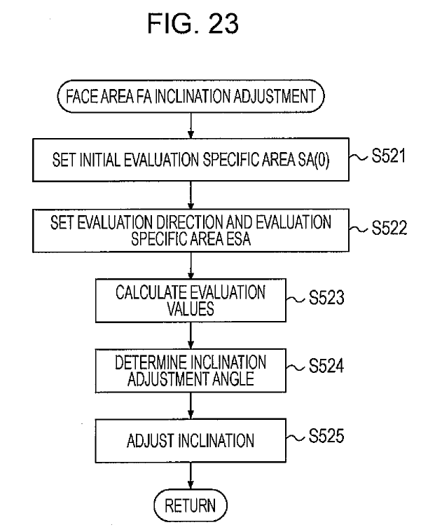

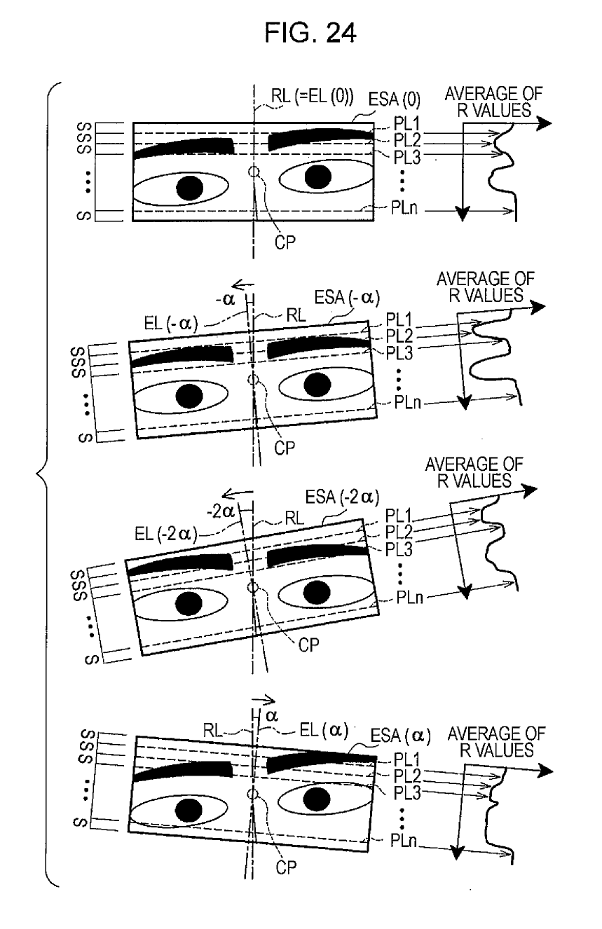

FIG. 23 is a flowchart of an inclination adjustment process to adjust the inclination of the face area FA according to the first example embodiment. In addition, FIG. 24 is a view that illustrates one example of a method of calculating evaluation values used for adjusting the inclination of the face area FA. In step S521 (FIG. 23), the face area adjustment unit 230 (FIG. 1) sets an initial evaluation specific area ESA(0) that is associated with a direction (hereinafter, also referred to as “initial evaluation direction”) parallel to the reference line RL (see FIG. 22) that is obtained after the position of the face area FA has been adjusted. In the present example embodiment, the specific area SA (see FIG. 22) corresponding to the face area FA of which the position has been adjusted is set as the initial evaluation specific area ESA(0) as it is. The evaluation specific area ESA used for adjusting the inclination of the face area FA is not divided into two right and left areas, different from the specific area SA that is used when the position of the face area FA is adjusted. The set initial evaluation specific area ESA(0) is shown in the uppermost drawing of FIG. 24.

In step S522 (FIG. 23), the face area adjustment unit 230 (FIG. 1) sets a plurality of evaluation directions and an evaluation specific area ESA corresponding to each of the evaluation directions. The plurality of evaluation directions represent the choices of adjustment angles of inclination. In the present example embodiment, a plurality of evaluation direction lines EL, of which an angle that is made with the reference line RL falls within a predetermined range, are set, and directions parallel to the evaluation direction lines EL are set as evaluation directions. As shown in FIG. 24, straight lines that are determined in such a manner that the reference line RL is rotated about the center point (center of gravity) CP of the initial evaluation specific area ESA(0) on a predetermined angle a basis in a counterclockwise direction or in a clockwise direction are set as the plurality of evaluation direction lines EL. The evaluation direction line EL of which an angle that is made with the reference line RL is φ degrees is denoted as EL(φ).

In the present example embodiment, the above described predetermined range with respect to an angle that is made by each evaluation direction line EL with the reference line RL is set to a range of ±20 degrees. In this description, a rotation angle is indicated by a positive value when the reference line RL is rotated in a clockwise direction, and by a negative value when the reference line RL is rotated in a counterclockwise direction. The face area adjustment unit 230 rotates the reference line RL in a counterclockwise or clockwise direction while increasing a rotation angle like α degrees, 2α degrees, . . . within a range that does not exceed 20 degrees to thereby set the plurality of evaluation direction lines EL. FIG. 24 shows the evaluation direction lines EL (EL(−α), EL(−2α), EL(α)) that are respectively determined by rotating the reference line RL at −α degrees, −2α degrees, and α degrees. The reference line RL may also be expressed as an evaluation direction line EL(0).

The evaluation specific area ESA corresponding to the evaluation direction line EL that represents each of the evaluation directions is obtained by rotating the initial evaluation specific area ESA(0) about the center point CP at the same angle as the rotation angle when the evaluation direction line EL is set. The evaluation specific area ESA corresponding to the evaluation direction line EL(φ) is denoted as an evaluation specific area ESA(φ). FIG. 24 shows the evaluation specific areas ESA (ESA(−α), ESA(−2α), and ESA(α)) that respectively correspond to the evaluation direction lines EL(−α), EL(−2α), and EL(α). The initial evaluation specific area ESA(0) is also treated as one of the evaluation specific areas ESA.

In step S523 (FIG. 23), the face area adjustment unit 230 (FIG. 1) calculates evaluation values on the basis of pixel values of an image of the evaluation specific area ESA with respect to each of the plurality of set evaluation directions. In the present example embodiment, the average values of R values are used as evaluation values for adjusting the inclination of the face area FA as in the case of the above described evaluation value for adjusting the position of the face area FA. The face area adjustment unit 230 calculates evaluation values for the plurality of evaluation positions located along the evaluation direction.

The method of calculating the evaluation value is the same as the above described method of calculating the evaluation value for adjusting the position of the face area FA. That is, the face area adjustment unit 230, as shown in FIG. 24, sets the target pixel specifying lines PL1 to PLn perpendicular to the evaluation direction line EL within each of the evaluation specific areas ESA, selects the evaluation target pixels TP with respect to each of the target pixel specifying lines PL1 to PLn, and then calculates the average of R values of the selected evaluation target pixels TP as the evaluation value.

A method of setting the target pixel specifying lines PL within the evaluation specific area ESA, or a method of selecting the evaluation target pixels TP, are the same as the method of adjusting the position of the face area FA shown in FIG. 18, FIG. 19A and FIG. 19B, except whether an area is divided into right and left areas. As in the case of the adjustment of position of the face area FA, a portion of the selected evaluation target pixels TP (for example, 0.75 k pixels having a relatively large R values among the evaluation target pixels TP) may be excluded from calculation of evaluation values. On the right side of FIG. 24, in regard to each of the evaluation directions, a distribution of the calculated evaluation values along the evaluation direction line EL is shown.

The target pixel specifying line PL is a straight line perpendicular to the evaluation direction line EL, so that the evaluation values may be calculated with respect to a plurality of positions (evaluation positions) along the evaluation direction line EL. In addition, the evaluation value may be regarded as a value that represents the characteristics of a distribution of pixel values along the direction perpendicular to the evaluation direction line EL with respect to each of the evaluation positions.

In step S524 (FIG. 23), the face area adjustment unit 230 (FIG. 1) determines an adjustment angle that is used to adjust the inclination of the face area FA. With respect to each of the evaluation directions, the face area adjustment unit 230 calculates in step S523 a distribution of the evaluation values along the evaluation direction line EL and selects an evaluation direction that has a maximum variance. Then, an angle made by the evaluation direction line EL, which corresponds to the selected evaluation direction, with the reference line RL is determined as an adjustment angle used for adjusting the inclination.

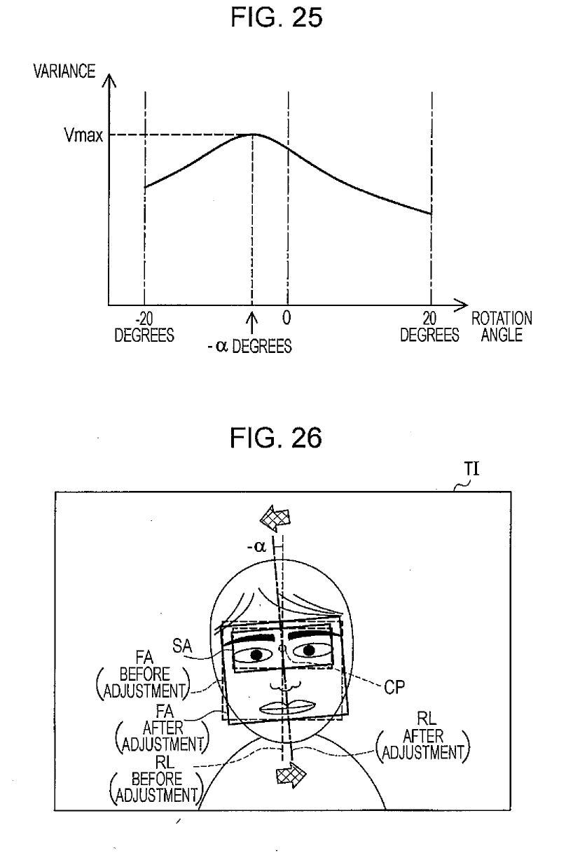

FIG. 25 is a view that illustrates one example of the calculation result of variance of evaluation values with respect to each evaluation direction. In the example shown in FIG. 25, the variance takes a maximum value Vmax in the evaluation direction of which the rotation angle is −α degrees. Thus, −α degrees, that is, a rotation angle of α degrees in a counterclockwise direction, is determined as an adjustment angle used for adjusting the inclination of the face area FA.

The reason that an angle corresponding to the evaluation direction in which the value of a variance of evaluation values becomes maximal is determined as an adjustment angle used for adjusting the inclination will now be described. As shown by the second drawing of FIG. 24 from the upper side, in the evaluation specific area ESA(−α) in which the rotation angle is −α degrees, the images of the center portions (black eye portions) of right and left eyes are arranged so that they are aligned in a direction substantially parallel to the target pixel specifying line PL (that is, a direction perpendicular to the evaluation direction line EL). Similarly, at this time, the images of right and left eyebrows are also arranged so that they are aligned in a direction substantially perpendicular to the evaluation direction line EL. Accordingly, the evaluation direction corresponding to the evaluation direction line EL at this time may be regarded as a direction that substantially represents the inclination of a face image. At this time, the positional relationship between the image of an eye or an eyebrow generally having small R values and the image of a skin portion generally having large R values will be a positional relationship in which both of the images have less overlapping portions along the direction of the target pixel specifying line PL. Therefore, the evaluation value at a position of the image of an eye or an eyebrow is relatively small, and the evaluation value at a position of the image of a skin portion is relatively large. Thus, the distribution of evaluation values along the evaluation direction line EL will have a relatively large dispersion (large amplitude), as shown in FIG. 24, and the value of a variance becomes large.

On the other hand, as shown in the uppermost, third and fourth drawings of FIG. 24, in the evaluation specific areas ESA(0), ESA(−2α), and ESA(α) in which the rotation angles are respectively 0 degrees, −2α degrees, and α degrees, the images of the center portions of right and left eyes or the images of right and left eyebrows are not aligned in a direction perpendicular to the evaluation direction line EL but deviated from each other. Thus, the evaluation direction corresponding to the evaluation direction line EL at this time does not represent the inclination of the face image. At this time, the positional relationship between the image of an eye or an eyebrow generally having small R values and the image of a skin portion generally having large R values will be a positional relationship in which both of the images have much overlapping portions along the direction of the target pixel specifying line PL. Thus, the distribution of evaluation values along the evaluation direction line EL will have a relatively small dispersion (small amplitude), as shown in FIG. 24, and the value of a variance becomes small.

As described above, when the evaluation direction is close to the direction of inclination of the face image, the value of a variance of the evaluation values along the evaluation direction line EL becomes large, and, when the evaluation direction is remote from the direction of inclination of the face image, the value of a variance of the evaluation values along the evaluation direction line EL becomes small. Thus, when an angle corresponding to the evaluation direction in which the value of a variance of the evaluation values becomes maximum is determined as an adjustment angle used for adjusting the inclination, it is possible to realize the adjustment of inclination of the face area FA such that the inclination of the face area FA conforms to the inclination of the face image.

In the present example embodiment, when the calculation result of the variance of the evaluation values is a critical value within the range of angles, that is, when the calculation result becomes a maximum value at an angle of −20 degrees or 20 degrees, it may be presumed that the inclination of a face is probably not properly evaluated. Thus, the adjustment of inclination of the face area FA is not executed in this case.

In addition, in the present example embodiment, the determined adjustment angle is compared with the approximate inclination angle RI that has been calculated when the position of the face area FA is adjusted as described above. When a difference between the adjustment angle and the approximate inclination angle RI is larger than a predetermined threshold value, it may be presumed that an error has occurred when an evaluation or determination has been made in adjusting the position of the face area FA or in adjusting the inclination thereof. Thus, the adjustment of position of the face area FA and the adjustment of inclination thereof are not executed in this case.

In step S525 (FIG. 23), the face area adjustment unit 230 (FIG. 1) adjusts the inclination of the face area FA. FIG. 26 is a view that illustrates one example of a method of adjusting the inclination of the face area FA. The adjustment of inclination of the face area FA is performed in such a manner that the face area FA is rotated about the center point CP of the initial evaluation specific area ESA(0) by the adjustment angle that is determined in step S524. In the example of FIG. 26, by rotating the face area FA of which the angle has not yet been adjusted, indicated by the broken line, in a counterclockwise direction by α degrees, the face area FA of which the angle has been adjusted, indicated by the solid line, is set.

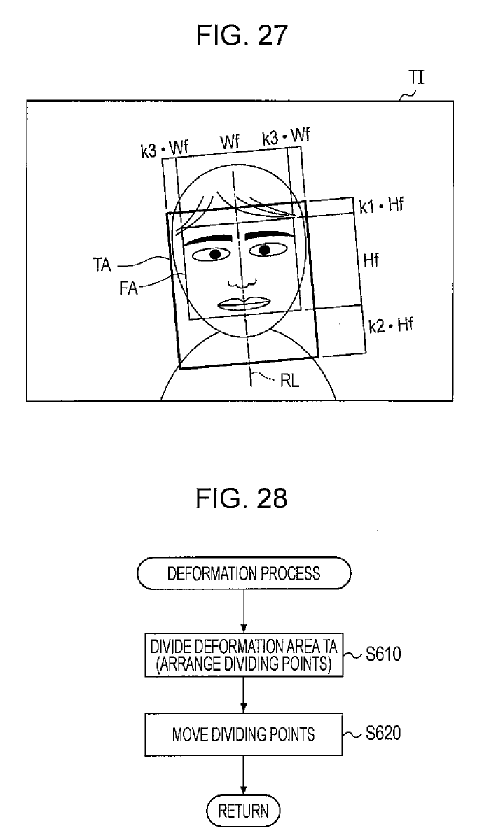

In step 530 (FIG. 15) after the adjustment of inclination of the face area FA has been completed, the deformation area setting unit 240 (FIG. 1) sets a deformation area TA. The deformation area TA is an area on the target image TI on which image deformation processing is performed for face shape correction. FIG. 27 is a view that illustrates one example of a method of setting the deformation area TA. As shown in FIG. 27, the deformation area TA is set such that the face area FA is extended (or contracted) in a direction parallel to the reference line RL (height direction) and in a direction perpendicular to the reference line RL (width direction). Specifically, where the size of the face area FA in the height direction is Hf, the size of the face area FA in the width direction is Wf, an area that is obtained by extending the face area FA upward by an amount of k1·Hf and downward by an amount of k2·Hf and by extending the face area FA to the right side and to left side, respectively, by an amount of k3·Wf is set as the deformation area TA. Note that k1, k2, and k3 are predetermined coefficients.

When the deformation area TA is set in this manner, the reference line RL, which is a straight line parallel to the contour line of the face area FA in the height direction, will also be parallel to the contour line of the deformation area TA in the height direction. In addition, the reference line RL divides the width of the deformation area TA in half.

As shown in FIG. 27, the deformation area TA is set to include the image substantially from the jaw to the forehead with respect to the height direction and to include the images of right and left cheeks with respect to the width direction. That is, the coefficients k1, k2, and k3 are set in advance on the basis of the relationship with the size of the face area FA so that the deformation area TA substantially includes the image of the above described range.

### A-4. Deformation Process

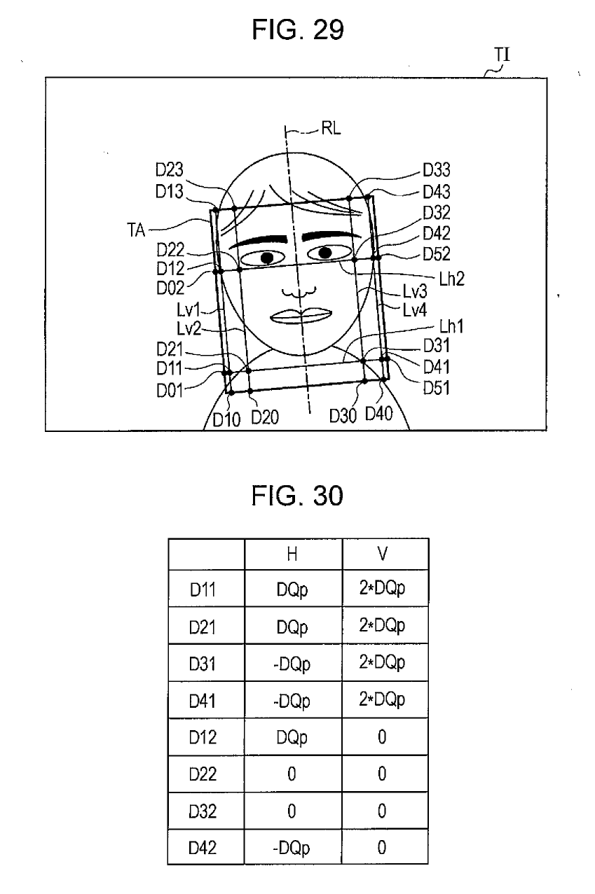

The deformation process (step S600) in the above described face shape correction process (FIG. 4) will now be specifically described. FIG. 28 is a flowchart of the deformation process. In step S610, the deformation area dividing unit 250 (FIG. 1) divides the deformation area TA into a plurality of small areas. FIG. 29 is a view that illustrates one example of a method of dividing the deformation area TA into small areas. The deformation area dividing unit 250 arranges a plurality of dividing points D in the deformation area TA and then divides the deformation area TA into a plurality of small areas using the straight lines that connect the dividing points D.

The mode of arrangement of the dividing points D (the number and positions of the dividing points D) is defined in the dividing point arrangement pattern table 410 (FIG. 1) in association with a deformation type that is set in step S120 (FIG. 4). The deformation area dividing unit 250 references the dividing point arrangement pattern table 410 and then arranges dividing points D in the mode that is associated with the deformation type set in step S120. In the present example embodiment, as described above, because the deformation “type A” (see FIG. 5) for sharpening a face is set as the deformation type, the dividing points D are arranged in the mode that is associated with this deformation type.

As shown in FIG. 29, the dividing points D are arranged at intersections of horizontal dividing lines Lh and vertical dividing lines Lv and at intersections of the horizontal dividing lines Lh or vertical dividing lines Lv and the outer frame line of the deformation area TA. Here, the horizontal dividing lines Lh and the vertical dividing lines Lv are reference lines for arranging the dividing points D in the deformation area TA. As shown in FIG. 29, in arranging the dividing points D that are associated with the deformation type for sharpening a face, two horizontal dividing lines Lh perpendicular to the reference line RL and four vertical dividing lines Lv parallel to the reference line RL are set. The two horizontal dividing lines Lh are denoted as Lh1, Lh2 in the order from the lower side of the deformation area TA. In addition, the four vertical dividing lines Lv are denoted as Lv1, Lv2, Lv3, and Lv4 in the order from the left side of the deformation area TA.

In the deformation area TA, the horizontal dividing line Lh1 is arranged on the lower side relative to the image of the jaw, and the horizontal dividing line Lh2 is arranged immediately below the images of the eyes. In addition, the vertical dividing lines Lv1 and Lv4 each are arranged outside the image of the line of the cheek, and the vertical dividing lines Lv2 and Lv3 each are arranged outside the image of the outer corner of the eye. The arrangement of the horizontal dividing lines Lh and vertical dividing lines Lv is executed in accordance with the correspondence relationship with the size of the deformation area TA that is set in advance so that the positional relationship between the horizontal dividing lines Lh or vertical dividing lines Lv and the image eventually becomes the above described positional relationship.

In accordance with the above described arrangement of the horizontal dividing lines Lh and vertical dividing lines Lv, the dividing points D are arranged at the intersections of the horizontal dividing lines Lh and the vertical dividing lines Lv and at the intersections of the horizontal dividing lines Lh or vertical dividing lines Lv and the outer frame line of the deformation area TA. As shown in FIG. 29, the dividing points D that are located on the horizontal dividing line Lhi (i=1 or 2) are denoted as D0i, D1i, D2i, D3i, D4i, and D5i in the order from the left side. For example, the dividing points D that are located on the horizontal dividing line Lh1 are denoted as D01, D11, D21, D31, D41, and D51. Similarly, the dividing points that are located on the vertical dividing line Lvj (j=any one of 1, 2, 3, and 4) are denoted as Dj0, Dj1, Dj2, and Dj3 in the order from the lower side. For example, the dividing points D that are located on the vertical dividing line Lv1 are denoted as D10, D11, D12, and D13.

As shown in FIG. 29, the dividing points D are arranged symmetrically with respect to the reference line RL.

The deformation area dividing unit 250 divides the deformation area TA into a plurality of small areas using the straight lines that connect the arranged dividing points D (that is, the horizontal dividing lines Lh and the vertical dividing lines Lv). In the present example embodiment, as shown in FIG. 29, the deformation area TA is divided into 15 rectangular small areas.

Because the arrangement of the dividing points D is determined on the basis of the number and positions of the horizontal dividing lines Lh and vertical dividing lines Lv, the dividing point arrangement pattern table 410 may be regarded as defining the number and positions of the horizontal dividing lines Lh and vertical dividing lines Lv.

In step S620 (FIG. 28), the divided area deformation unit 260 (FIG. 1) executes the image deformation process on the deformation area TA of the target image TI. The deformation process is executed by the divided area deformation unit 260 in such a manner that the positions of the dividing points D within the deformation area TA are moved in step S610 to thereby deform the small areas.

The moving mode (moving direction and moving distance) of the position of each dividing point D for deformation process is determined in advance in association with the combinations of the deformation type and the degree of deformation, which are set in step S120 (FIG. 4), by the dividing point moving table 420 (FIG. 1). The divided area deformation unit 260 references the dividing point moving table 420 and moves the positions of the dividing points D using the moving direction and moving distance that are in association with the combination of the deformation type and the degree of deformation, which are set in step S120.

When the deformation “type A” (see FIG. 5) for sharpening a face is set as the deformation type, and the degree of extent “Middle” is set as the deformation degree, the positions of the dividing points D are moved using the moving direction and the moving distance, which are associated with the combination of these deformation type and deformation degree.

When “Automatic” is selected as the deformation degree, the moving direction and the moving distance of the dividing points D are determined on the basis of the deformation quantity DQ that is set by the deformation quantity setting unit 290.

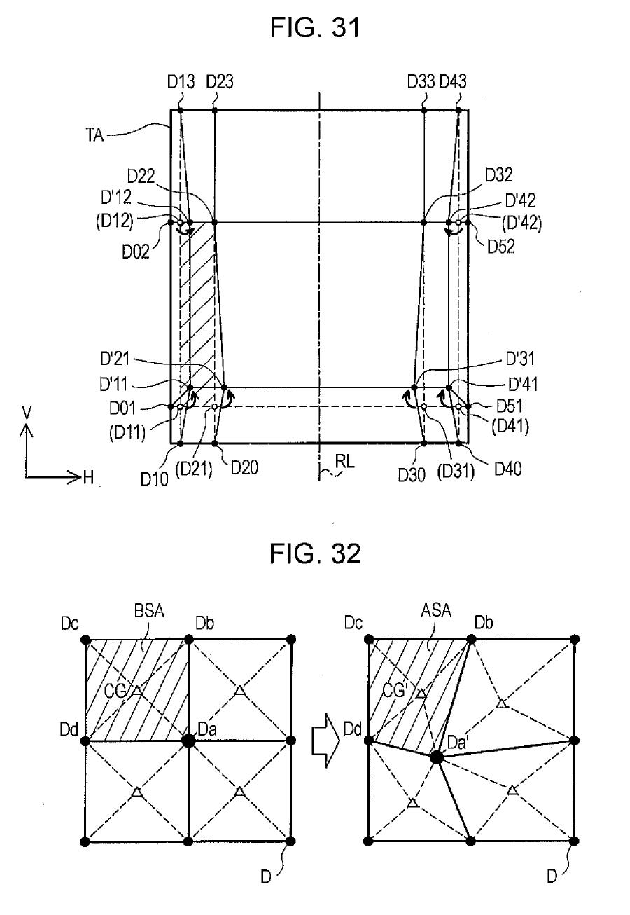

FIG. 30 is a view that illustrates one example of the content of the dividing point moving table 420. FIG. 31 is a view that illustrates one example of movement of positions of dividing points D in accordance with the dividing point moving table 420. FIG. 30 shows, among the moving modes of the positions of the dividing points D defined by the dividing point moving table 420, a moving mode that is associated with the combination of the deformation type for sharpening a face and the deformation degree “Automatic”. As shown in FIG. 30, the dividing point moving table 420 indicates, with respect to each of the dividing points D, the amount of movement along a direction (H direction) perpendicular to the reference line RL and along a direction (V direction) parallel to the reference line RL. The unit of the amount of movement shown in the dividing point moving table 420 is a pixel pitch PP of the target image TI. In addition, the deformation quantity DQp in the table is determined by the deformation quantity setting unit 290 (FIG. 1). In step S590 of FIG. 4, the deformation quantity setting unit 290 calculates the deformation quantity DQp by converting the set deformation quantity DQ to a pixel pitch. In regard to the H direction, the amount of movement toward the right side is indicated by a positive value and the amount of movement toward the left side is indicated by a negative value. In regard to the V direction, the amount of upward movement is indicated by a positive value and the amount of downward movement is indicated by a negative value. For example, the dividing points D11 are moved toward the right side by a distance of DQp times the pixel pitch PP along the H direction and are moved upward by a distance of 2*DQp times the pixel pitch PP along the V direction. In addition, for example, the amount of movement of the dividing point D22 is zero in both the H direction and V direction, so that the dividing point D22 will not be moved. When any one of “Strong (S)”, “Middle (M)” and “Weak (W)” is selected as the deformation degree, the deformation quantity DQp employs a value that is determined in advance in association with each of the deformation degrees in place of a value that is adjusted by the deformation quantity setting unit 290.

In order to avoid making the boundary between the images inside and outside the deformation area TA unnatural, the positions of the dividing points D (for example, the dividing point D10, and the like, shown in FIG. 29) located on the outer frame line of the deformation area TA are not moved. Thus, the dividing point moving table 420 shown in FIG. 30 does not define a moving mode with respect to the dividing points D that are located on the outer frame line of the deformation area TA.

FIG. 31 shows the dividing points D that have not yet been moved using the outline circle and shows the dividing points D that have been moved or the dividing points D of which the positions will not be moved using the solid circle. The dividing points D that have been moved are denoted by dividing points D′. For example, the position of the dividing point D11 is moved in an upper right direction in FIG. 31 and then it will be a dividing point D′11.

In the present example embodiment, the moving mode is determined so that all the pairs of the dividing points D that are symmetrically located with respect to the reference line RL (for example, the pair of the dividing point D11 and the dividing point D41) maintain a symmetrical positional relationship with respect to the reference line RL even after the dividing points D have been moved.

The divided area deformation unit 260 executes an image deformation process on each of the small areas that constitute the deformation area TA so that the images of the small areas in a state where the positions of the dividing points D have not yet been moved become images of small areas that are newly defined through the position movement of the dividing points D. For example, in FIG. 31, the image of a small area (the small area indicated by hatching) having vertexes of dividing points D11, D21, D22, and D12 is deformed into the image of a small area having vertexes of dividing points D′11, D′21, D22, and D′12.

FIG. 32 is a view that illustrates the concept of a deformation processing method of an image using the divided area deformation unit 260. In FIG. 32, the dividing points D are shown using solid circles. FIG. 32 shows, with respect to four small areas, the state of dividing points D, of which the positions have not yet been moved, on the left side and the state of dividing points D, of which the positions have been moved, on the right side, respectively, for easy description. In the example shown in FIG. 32, a center dividing point Da is moved to the position of a dividing point Da′, and the positions of the other dividing points will not be moved. In this manner, for example, the image of a rectangular small area (hereinafter, also referred to as “pre-deformation focusing small area BSA”) having the vertexes of dividing points Da, Db, Dc, and Dd of which the positions of the dividing points D have not yet been moved is deformed into the image of a rectangular small area (hereinafter, also referred to as “post-deformation focusing small area ASA”) having the vertexes of the dividing points Da′, Db, Dc, and Dd.

In the present example embodiment, the rectangular small area is divided into four triangle areas using the center of gravity CG of the rectangular small area, and the image deformation process is executed on a triangle area basis. In the example of FIG. 32, the pre-deformation focusing small area BSA is divided into four triangle areas, each having one of the vertexes at the center of gravity CG of the pre-deformation focusing small area BSA. Similarly, the post-deformation focusing small area ASA is divided into four triangle areas, each having one of the vertexes at the center of gravity CG′ of the post-deformation focusing small area ASA. Then, the image deformation process is executed for each of the triangle areas corresponding to the respective states of the dividing point Da before and after movement. For example, the image of a triangle area that has the vertexes of dividing points Da, Dd and the center of gravity CG within the pre-deformation focusing small area BSA is deformed into the image of a triangle area that has the vertexes of dividing points Da′, Dd and the center of gravity CG′ within the post-deformation focusing small area ASA.

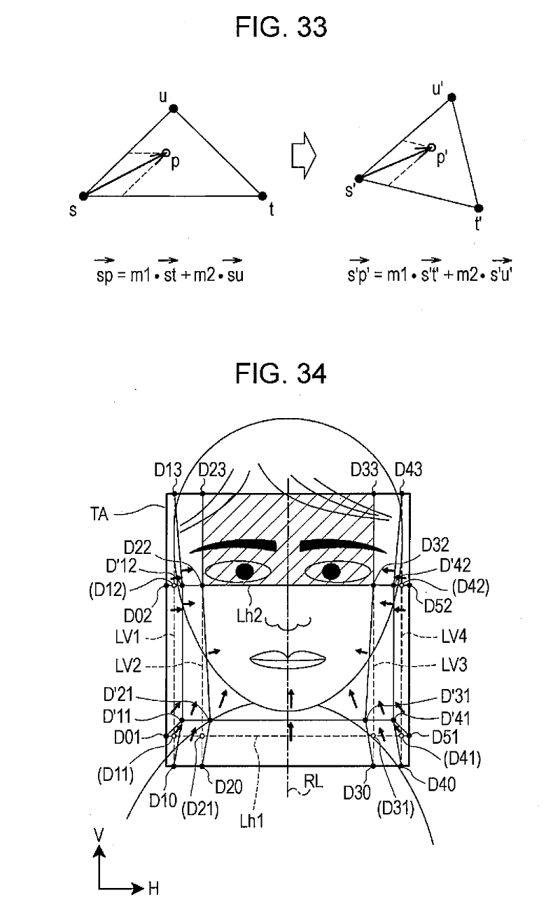

FIG. 33 is a view that illustrates the concept of a method of performing deformation process on an image in a triangle area. In the example of FIG. 33, the image of a triangle area stu that has the vertexes of points s, t, and u is deformed into the image of a triangle area s′t′u′ that has the vertexes of points s′, t′, and u′. The deformation of an image is performed in such a manner that which one of the positions in the image of the triangle area stu that has not yet been deformed corresponds to each of the positions of pixels in the image of the triangle area s′t′u′ that has been deformed is calculated, and pixel values in the image that has not yet been deformed at the positions calculated are set to pixel values of the image that has been deformed.

For example, in FIG. 33, the position of a focusing pixel p′ in the image of the triangle area s′t′u′ that has been deformed corresponds to a position p in the image of the triangle area stu that has not yet been deformed. The calculation of the position p is performed in the following manner. First, coefficients m1 and m2 that are used to represent the position of the focusing pixel p′ using the sum of a vector s′t′ and a vector s′u′ shown in the following Equation (4) are calculated.

\vec{s′p′}=m1·\vec{s′t′}+m2·\vec{s′u′} (4)

Next, using the calculated coefficients m1 and m2, the sum of a vector st and a vector su in the triangle area stu that has not yet been deformed is calculated through the following Equation (5) and, as a result, the position p is obtained.

\vec{sp}=m1·\vec{st}+m2·\vec{su} (5)

When the position p in the triangle area stu that has not yet been deformed coincides with a pixel center position of the image that has not yet been deformed, the pixel value of that pixel is set as a pixel value of the image that has been deformed. On the other hand, when the position p in the triangle area stu that has not yet been deformed becomes a position deviated from the pixel center position of the image that has not yet been deformed, a pixel value at the position p is calculated by means of interpolation computing, such as bicubic, that uses the pixel values of pixels around the position p, and then the calculated pixel value is set to a pixel value of the image that has been deformed.

By calculating the pixel value as described above in regard to each pixel of the image in the triangle area s′t′u′ that has been deformed, it is possible to execute image deformation process by which the image of the triangle area stu is deformed into the image of the triangle area s′t′u′. The divided area deformation unit 260, in terms of each of the small areas that constitute the deformation area TA shown in FIG. 31, defines the triangle area as described above and executes the deformation process, thus executing the image deformation process on the deformation area TA.

The mode of face shape correction, when the deformation “type A” (see FIG. 5) for sharpening a face is set as the deformation type and the “Automatic” is set as the deformation degree, will now be described in more detail. FIG. 34 is a view that illustrates one example of the mode of face shape correction in the above case. In FIG. 34, the image of deformation mode of each of the small areas that constitute the deformation area TA is shown by the arrow.

In the face shape correction shown in the example of FIG. 34, with respect to a direction (V direction) parallel to the reference line RL, the positions of the dividing points D (D11, D21, D31, D41) that are arranged on the horizontal dividing line Lh1 are moved upward, while, on the other hand, the positions of the dividing points D (D12, D22, D32, D42) that are arranged on the horizontal dividing line Lh2 are not moved (see FIG. 30). Thus, the image located between the horizontal dividing line Lh1 and the horizontal dividing line Lh2 is reduced with respect to the V direction. As described above, because the horizontal dividing line Lh1 is arranged on the lower side relative to the image of the jaw, and the horizontal dividing line Lh2 is arranged immediately below the images of the eyes, in the face shape correction, within the image of the face, the image of an area extending from the jaw to a portion below the eyes is reduced in the V direction. As a result, the line of the jaw in the image is moved upward.

On the other hand, with respect to a direction (H direction) perpendicular to the reference line RL, the positions of the dividing points D (D11, D12) that are arranged on the vertical dividing line Lv1 are moved to the right direction, and the positions of the dividing points D (D41, D42) that are arranged on the vertical dividing line Lv4 are moved to the left direction (see FIG. 30). Furthermore, among two dividing points D that are arranged on the vertical dividing line Lv2, the position of the dividing point D (D21) that is arranged on the horizontal dividing line Lh1 is moved to the right direction, and, among two dividing points D that are arranged on the vertical dividing line Lv3, the position of the dividing point D (D31) that is arranged on the horizontal dividing line Lh1 is moved to the left direction (see FIG. 30). Thus, the image that is located on the left side with respect to the vertical dividing line Lv1 is enlarged to the right side in the H direction, and the image on the right side with respect to the vertical dividing line Lv4 is enlarged to the left side in the H direction. In addition, the image that is located between the vertical dividing line Lv1 and the vertical dividing line Lv2 is reduced or moved to the right side in the H direction, and the image that is located between the vertical dividing line Lv3 and the vertical dividing line Lv4 is reduced or moved to the left side in the H direction. Furthermore, the image that is located between the vertical dividing line Lv2 and the vertical dividing line Lv3 is reduced in the H direction using the position of the horizontal dividing line Lh1 as a center.

As described above, the vertical dividing lines Lv1 and Lv4 each are located outside the image of the line of the cheek, the vertical dividing lines Lv2 and Lv3 each are arranged outside the image of the outer corner of the eye. Therefore, in the face shape correction of the example of FIG. 34, within the image of the face, the images of portions outside both the outer corners of the eyes are entirely reduced in the H direction. Particularly, the reduction ratio is high around the jaw. As a result, the shape of the face in the image is entirely narrowed in the width direction.

When the deformation modes in the H direction and in the V direction, described above, are combined, the shape of the face in the target image TI is sharpened through the face shape correction shown in the example of FIG. 34. Sharpening of the shape of a face may be expressed as so-called becoming a “small face”.

The small areas (hatched areas) having the vertexes at the dividing points D22, D32, D33, and D23 shown in FIG. 34 include the images of both eyes when the above described method of arranging the horizontal dividing line Lh2 and the vertical dividing lines Lv2 and Lv3 is used. As shown in FIG. 30, because the dividing points D22 and D32 are not moved in the H direction or in the V direction, the small area that includes the images of both eyes is not deformed. In the example of FIG. 34 as described above, the small area that includes the images of both eyes is not deformed, so that the image on which face shape correction has been executed becomes more natural and desirable.

### A-5. Other Deformation Process

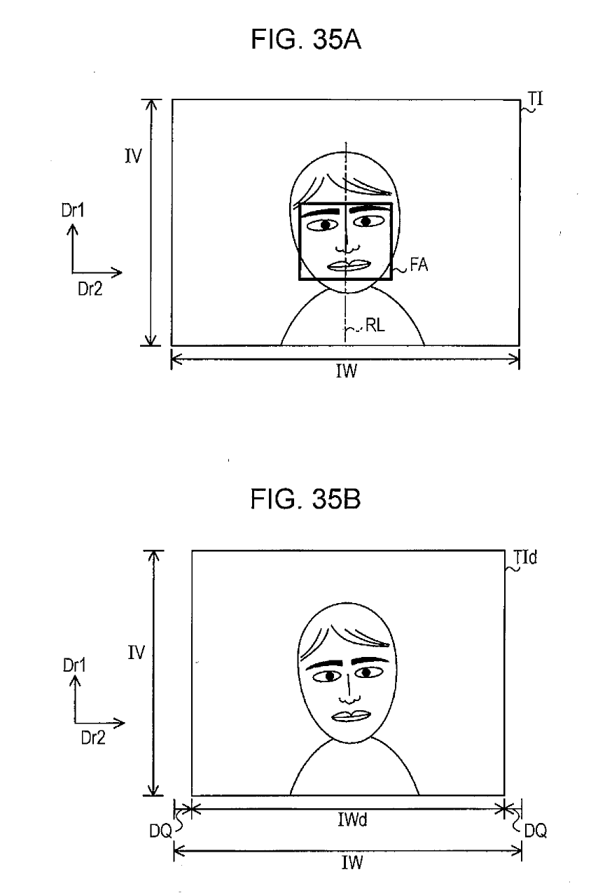

FIG. 35A and FIG. 35B are schematic views, each of which shows another example embodiment of a deformation process. As is different from the deformation process shown in FIG. 9A and FIG. 9B, in the examples of FIG. 35A and FIG. 35B, the entire aspect ratio of the target image TI is changed in place of portion of the deformation area on the target image TI being deformed.

FIG. 35A shows the target image TI before deformation, and FIG. 35B shows an image TId after deformation. In addition, two directions Dr1 and Dr2 that are perpendicular to each other are shown in the drawing. The first direction Dr1 indicates a direction parallel to the short side of the rectangular image TI or TId, and the second direction Dr2 indicates a direction parallel to the long side of the rectangular image TI or TId. In each of the examples of FIG. 35A and FIG. 35B, the width direction of the face substantially coincides with the second direction Dr2.

In each of the examples of FIG. 35A and FIG. 35B, deformation along the first direction Dr1 is not executed, and deformation (compression) along the second direction Dr2 is executed. Through this deformation, the entire image is compressed along the second direction Dr2. That is, the width of the subject on the target image TI is also narrowed. As a result, it is possible to approximate the impression of the subject obtained by observing an image to the impression obtained by observing the actual subject.

In this deformation, the size (width IWd) of the deformed image TId in the second direction Dr2 is smaller by twice the deformation quantity DQ than the size (width IW) of the image before deformation. That is, the number of pixels of the deformed image TId in the second direction Dr2 is smaller than the number of pixels of that image before deformation. Here, the method of determining pixel values (gray scale values of the pixels) of the deformed image TId may employ various methods. For example, by interpolating pixel values of the target image TI, the pixel values of the deformed image TId may be determined.

The deformation quantity DQ may employ a selected deformation quantity that is described in the above described embodiments. For example, the deformation quantity DQ that is determined on the basis of the subject distance Sd may be employed.

It is desirable to select a direction to be compressed from among two directions Dr1 and Dr2 on the basis of the detection result of the orientation of the subject. For example, the face area detection unit 220 (FIG. 1), as shown in FIG. 14 and FIG. 35A, is able to detect the reference line RL that indicates the height direction (up and down direction) of the face area FA. Then, it is desirable to select, between the two directions Dr1 and Dr2, a direction in which an angle made with this reference line RL is larger (in each of the examples of FIG. 35A and FIG. 35B, second direction Dr2). In this manner, it is possible to reduce the width (the size in the horizontal direction) of the subject.

When the deformation process that changes the entire aspect ratio of the target image TI is employed, the face shape correction unit 200 shown in FIG. 1 may be employed as the face shape correction unit. However, it is possible to omit the deformation area dividing unit 250 and the divided area deformation unit 260 from the deformation processing unit. Instead, it is only necessary for the deformation processing unit to have the function of changing the aspect ratio of the target image TI. In addition, the face area adjustment unit 230 and the deformation area setting unit 240 may be omitted. The face area detection unit 220 may be used to detect the orientation of a subject. However, the face area detection unit 220 may be omitted.

In place of the deformation process in which the target image TI is compressed along the width direction of a subject, the deformation process in which the target image TI is extended along the height direction of a subject may be employed. In this case as well, because a ratio of the width to the height of the subject is reduced, it is possible to approximate the impression of the subject obtained by observing the image to the impression obtained by observing the actual subject.

### B. Second Example Embodiment

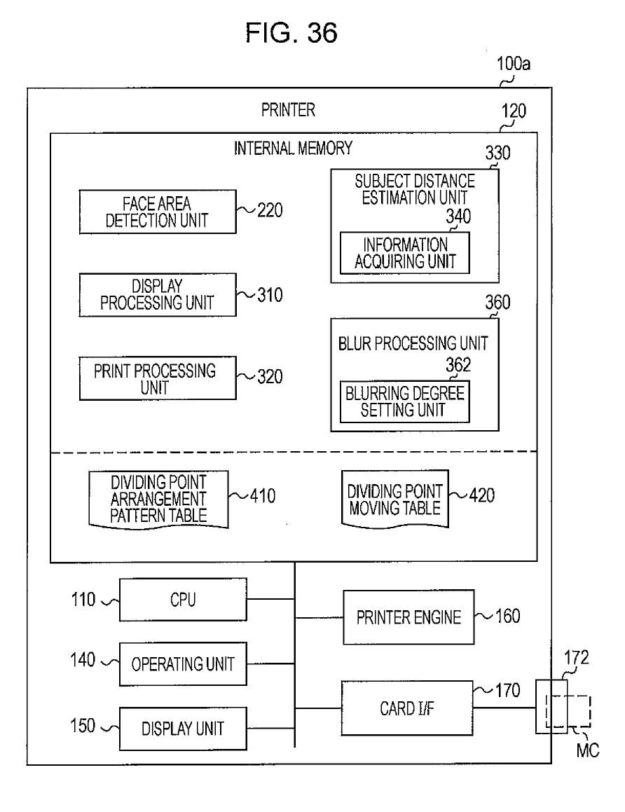

FIG. 36 is a view that schematically illustrates the configuration of a printer 100a, which serves as an image processing device, according to a second example embodiment of the invention. The printer 100a according to the second example embodiment differs from the printer 100 (FIG. 1) according to the first example embodiment in that the printer 100a according to the second example embodiment includes a blur processing unit 360 in place of the face shape correction unit 200. The remaining configuration of the printer 100a according to the second example embodiment is the same as that of the printer 100 according to the first example embodiment.

The blur processing unit 360 is a computer program that executes background blur printing process, which will be described later, under a predetermined operating system. The blur processing unit 360 includes a blurring degree setting unit 362.

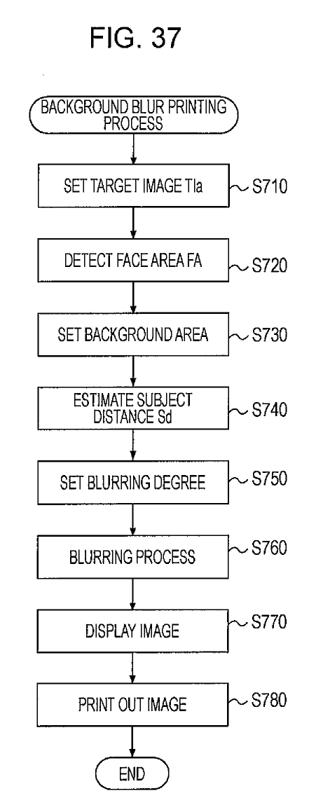

FIG. 37 is a flowchart of the background blur printing process performed by the printer 100a according to the second example embodiment. The background blur printing process is a process in which, after a blurring process has been executed on an image of a background area in the target image, printing is performed. Through the background blur printing process, it is possible to achieve printing of a perspective image of which a main subject is accentuated.

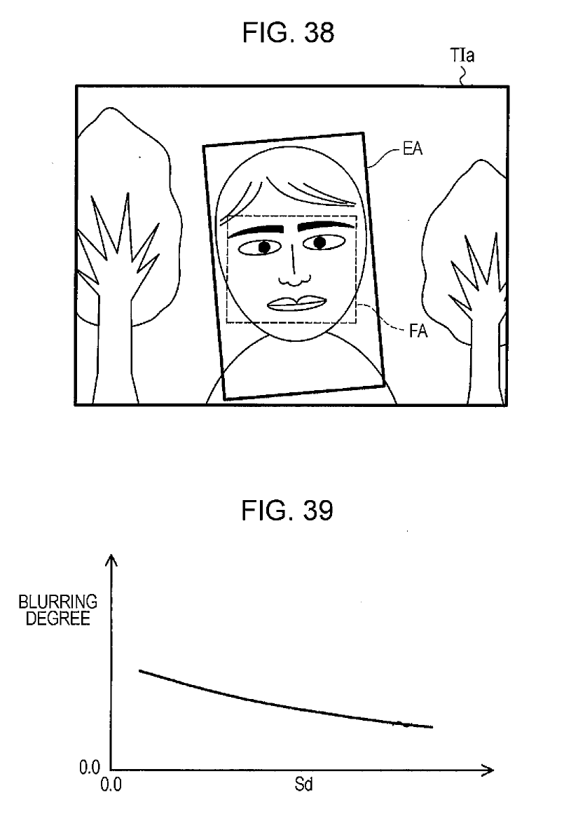

In step S710, the blur processing unit 360 (FIG. 36) sets a target image TIa for the background blur printing process. A method of setting the target image TIa is the same as the method of setting the target image in the face shape correction process (FIG. 4) according to the first example embodiment. FIG. 38 is a view that illustrates one example of the target image TIa of the background blur printing process.

In step S720 (FIG. 37), the face area detection unit 220 (FIG. 36) detects the face area FA in the target image TIa. A method of detecting the face area FA is the same as the method of detecting the face area FA in the face shape correction process (FIG. 4) according to the first example embodiment. In FIG. 38, the detected face area FA in the target image TIa is indicated by the broken line.

In step S730 (FIG. 37), the blur processing unit 360 sets a background area in the target image TIa on which a blurring process is executed. The blur processing unit 360 sets an excluded area EA on the basis of the face area FA detected in step S720, and sets an area that is obtained by excluding the excluded area EA from the target image TIa as the background area. FIG. 38 shows an example of the set excluded area EA in the target image TIa. Setting the excluded area EA, as well as setting the deformation area TA in the face shape correction process (FIG. 4) according to the first example embodiment, may be performed by expanding the face area FA using a predetermined coefficient. As shown in FIG. 38, the excluded area EA may be set to be larger than the deformation area TA (see FIG. 7) in the first example embodiment so as to include the image of substantially entire face. In addition, the excluded area EA may be set to include a substantially full-length image of a person.

In step S740 (FIG. 37), the subject distance estimation unit 330 (FIG. 36) estimates the subject distance Sd. A method of estimating the subject distance Sd is the same as the method of estimating the subject distance Sd in the face shape correction process (FIG. 4) according to the first example embodiment.

In step S750 (FIG. 37), the blurring degree setting unit 362 (FIG. 36) sets a blurring degree (also referred to as “blurring intensity”). The blurring degree is a degree (intensity) of a blurring process performed on the background area in the target image TIa. The blurring degree setting unit 362 sets the blurring degree on the basis of the relationship between a predetermined blurring degree and a subject distance Sd. FIG. 39 is a graph that shows the relationship between a blurring degree and a subject distance Sd. The abscissa axis represents a subject distance Sd, and the ordinate axis represents a blurring degree. As shown in FIG. 39, the relationship between the blurring degree and the subject distance Sd is determined so that the blurring degree increases as the subject distance Sd decreases. In a general image pickup apparatus, the depth of field becomes shallower as the imaging distance becomes shorter. Thus, the relationship between the blurring degree and the subject distance Sd is determined as shown in FIG. 39, so that natural and favorable blurring process is achieved. The blurring degree setting unit 362 sets the blurring degree on the basis of the subject distance Sd estimated in step S740 and the relationship shown in FIG. 39.

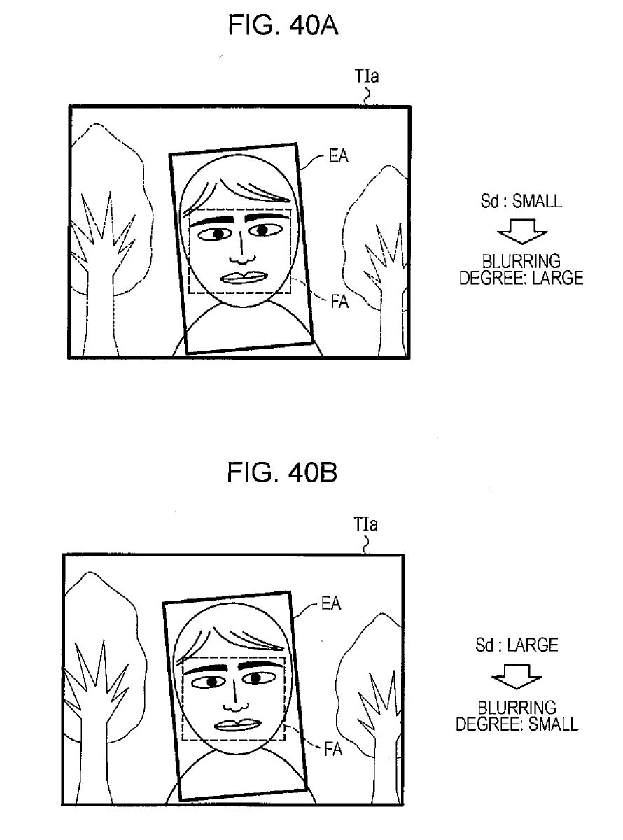

In step S760 (FIG. 37), the blur processing unit 360 (FIG. 36) executes the blurring process. The blur processing unit 360 executes the blurring process on the image of the background area that is set within the target image TIa in the blurring degree that is set in step S750. The blurring process may be executed by means of a known method using, for example, a Gaussian filter. FIG. 40A and FIG. 40B are views, each of which illustrates one example of the target image TIa on which the blurring process has been executed. FIG. 40A shows the target image TIa on which the blurring process has been executed when the subject distance Sd is relatively small. FIG. 40B shows the target image TIa on which the blurring process has been executed when the subject distance Sd is relatively large. As shown in FIG. 40A and FIG. 40B, as the degree of blurring of the background image increases, the subject distance Sd becomes smaller.

After that, displaying (step S770 in FIG. 37) and printing (step S780 in FIG. 37) of the image on which the blurring process has been executed are performed. Displaying and printing of the image on which the blurring process has been executed are performed in the same manner as displaying and printing of the image in the face shape correction printing process (FIG. 3) according to the first example embodiment.

As described above, in the printer 100a according to the second example embodiment, on the basis of the estimated subject distance Sd, the blurring degree is set so that the blurring degree increases as the subject distance Sd decreases, and the blurring process is executed on the image using the set blurring degree. Thus, it is possible to achieve a natural and favorable blurring process for an image, which is suitable for the characteristic of the image pickup apparatus.

The blurring process for an image according to the present example embodiment may be regarded as a specific process according to the aspects of the invention, and the blur processing unit 360 that executes the blurring process for an image according to the present example embodiment may be regarded as a specific process execution unit according to the aspects of the invention.

### C. Third Example Embodiment

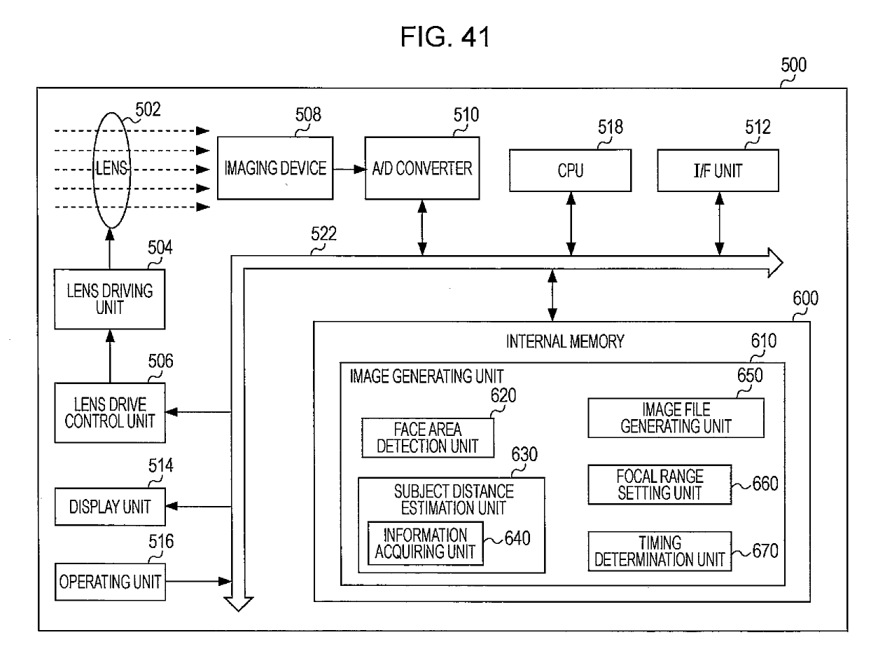

FIG. 41 is a view that schematically illustrates the configuration of a digital still camera 500, which serves as an image processing device, according to a third example embodiment of the invention. The digital still camera (hereinafter, referred to as “DSC”) 500 according to the third example embodiment functions as an image pickup apparatus (image generating device) that generates an image by imaging an object and functions as an image processing device that executes image processing on the generated image.

The DSC 500 includes a lens 502, a lens driving unit 504, a lens drive control unit 506, an image pickup device 508, an A/D converter 510, an interface unit (I/F unit) 512, a display unit 514, an operating unit 516, a CPU 518, and an internal memory 600. The lens driving unit 504 adjusts the position of a focal point (focus) and the focal length by driving the lens 502. The lens drive control unit 506 controls the lens driving unit 504. The image pickup device 508 converts light, which enters a light receiving plane through the lens 502, into an electrical signal. The A/D converter 510 performs A/D conversion on the electrical signal that is output from the image pickup device 508. The I/F unit 512 is used for exchanging information with external devices. The display unit 514 is formed of a liquid crystal display. The operating unit 516 is formed of a button or a touch panel. The CPU 518 controls various portions of the DSC 500. The internal memory 600 is formed of a ROM or a RAM. The image pickup device 508 is, for example, formed using a CCD. Various components of the DSC 500 are connected through a bus 522 to one another.

The internal memory 600 stores an image generating unit 610. The image generating unit 610 is a computer program that executes image generating process, which will be described later, under a predetermined operating system. The CPU 518 reads out these programs from the internal memory 600 and then executes the programs to thereby implement the function of the image generating unit 610.

The image generating unit 610 includes, as program modules, a face area detection unit 620, a subject distance estimation unit 630, an image file generating unit 650, a focal range setting unit 660, and a timing determination unit 670. In addition, the subject distance estimation unit 630 includes an information acquiring unit 640. The functions of these units will be specifically described later in the description of the image generating process. The face area detection unit 620 has the same function as the face area detection unit 220 included in the printer 100 (FIG. 1) according to the first example embodiment, and the subject distance estimation unit 630 has the same function as the subject distance estimation unit 330 included in the printer 100 according to the first example embodiment.

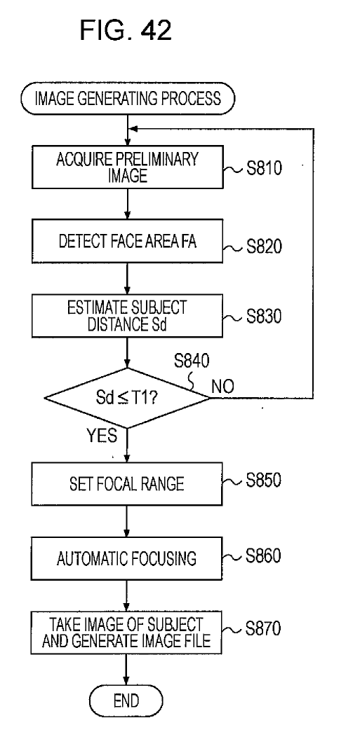

FIG. 42 is a flowchart of an image generating process executed by the DSC 500 according to the third example embodiment. In the image generating process according to the third example embodiment, imaging is performed when a predetermined condition is satisfied, and then an image file that contains image data representing the image is generated.

In step S810, the image generating unit 610 (FIG. 41) acquires a preliminary image used for various processes before imaging. The image generating unit 610 controls the lens 502, the image pickup device 508 and the A/D converter 510 to acquire the preliminary image. When the display unit 514 is used as a finder at the time of imaging, the preliminary image is displayed on the display unit 514.

In step S820 (FIG. 42), the face area detection unit 620 (FIG. 41) detects a face area FA in the preliminary image. A method of detecting the face area FA is the same as the method of detecting the face area FA in the face shape correction process (FIG. 4) according to the first example embodiment.

In step S830 (FIG. 42), the subject distance estimation unit 630 (FIG. 41) estimates a subject distance Sd in the preliminary image. A method of estimating the subject distance Sd is the same as the method of estimating the subject distance Sd in the face shape correction process (FIG. 4) according to the first example embodiment. That is, the information acquiring unit 640 acquires pieces of information, such as the overall width of the preliminary image, the width of the face area FA, the width of the face of a person P, the focal length of the lens and the width of the imaging plane, and the subject distance estimation unit 630 uses these pieces of information and Equation (3) to calculate (estimate) the subject distance Sd.

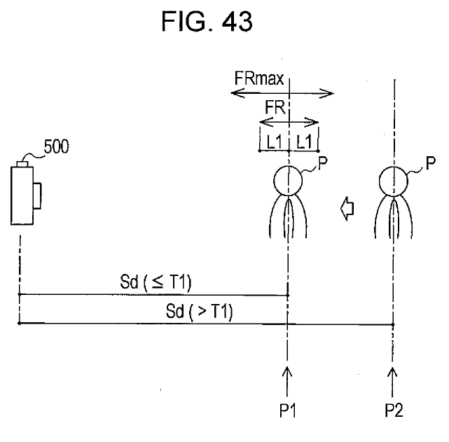

In step S840 (FIG. 43), the timing determination unit 670 (FIG. 41) determines an image generation timing (imaging timing) on the basis of the subject distance Sd that is estimated in step S830. FIG. 43 is a view that schematically illustrates the image generating process according to the third example embodiment. In the image generating process according to the third example embodiment, the condition that the subject distance Sd is equal to or smaller than a predetermined threshold value T1 is determined as a condition for generating an image (imaging). That is, when the person P, which serves as a subject, is present at a position P2 in FIG. 43, the above imaging condition is not satisfied and, therefore, imaging is not performed. On the other hand, as the person moves to a position P1, the above imaging condition is satisfied and imaging is then performed. The above imaging condition may be, for example, set as an imaging condition for a security camera.

In step S840, the timing determination unit 670 compares the subject distance Sd with the threshold value T1 and, when the subject distance Sd is equal to or smaller than the threshold value T1, it is determined to perform image generation and then proceeds to step S850. On the other hand, the timing determination unit 670, when the subject distance Sd is larger than threshold value T1, determines not to perform image generation and then returns to step S810. The processes from step S810 to S840 in FIG. 42 are repeatedly executed at predetermined intervals until it is determined to perform image generation in step S840.

In step S850 (FIG. 42), the focal range setting unit 660 (FIG. 41) sets a focal range FR on the basis of the subject distance Sd that is estimated in step S830. The focal range FR is a range within which the position of a focal point (focus) should be placed at the time of imaging. The focal range setting unit 660, as shown in FIG. 43, sets the focal range FR to extend by a predetermined distance L1 to both front and rear sides with respect to a position that is spaced the subject distance Sd away from the DSC 500. The focal range FR is set to be narrower than a maximum focal range FRmax, which is a maximum range within which a focal point can be placed in accordance with the mechanism of the DSC 500.

In step S860 (FIG. 42), the image generating unit 610 (FIG. 41) controls the lens 502, the lens driving unit 504 and the lens drive control unit 506 to perform automatic focusing (auto-focus). Specifically, the image generating unit 610, while moving the focal point within the focal range FR, acquires an image by imaging, and focuses a position corresponding to an image having a maximum contrast within the acquired image. In automatic focusing in a general DSC, while the focal point is moved within the maximum focal point range FRmax, the contrast of the acquired image is detected. On the other hand, in automatic focusing performed by the DSC 500 according to the present example embodiment, because, while the focal point is moved only within the focal range FR, which is a range narrower than the maximum focal range FRmax, the contrast of the acquired image is detected, it is possible to reduce time required for focusing.

In step S870 (FIG. 42), the image generating unit 610 (FIG. 41) generates image data through imaging, and the image file generating unit 650 generates an image file that contains the image data and the data that indicate the subject distance Sd that is estimated in step S830. The image file is, for example, generated in accordance with Exif specification, and the data that indicate the subject distance Sd are added to the image file as additive data.

As described above, in the image generating process performed by the DSC 500 according to the third example embodiment, the subject distance Sd in the preliminary image is estimated, and then image generation (imaging) timing is determined on the basis of the estimated subject distance Sd. Thus, it is possible to generate an image by determining an imaging condition in connection with the distance between the DSC 500 and the subject. In addition, in the image generating process performed by the DSC 500 according to the third example embodiment, the focal range FR is set on the basis of the estimated subject distance Sd and then automatic focusing is performed within the focal range FR. Thus, it is possible to reduce time required for focusing.

In addition, in the image generating process performed by the DSC 500 according to the third example embodiment, an image file that contains image data and data that indicate the subject distance Sd is generated. Thus, after the image file has been generated, using the data that indicate the subject distance Sd contained in the image file, it is possible to execute the face shape correction process described in the first example embodiment and the blurring process described in the second example embodiment. In addition, the data that indicate the subject distance Sd contained in the image file may also be used in searching an image. For example, it is possible to easily select an image of which the subject distance Sd is relatively small among a plurality of image files.

Generating an image file, determining an image generation timing and setting a focal range FR according to the present example embodiment may be regarded as a specific process according to the aspects of the invention, and the image file generating unit 650, the timing determination unit 670 and the focal range setting unit 660 that generate an image file, determine an image generation timing and set a focal range FR, respectively, according to the present example embodiment may be regarded as a specific process execution unit according to the aspects of the invention. In addition, the preliminary image according to the present example embodiment may be regarded as a target image according to the aspects of the invention.

### D. Alternative Example Embodiment

The invention is not limited to the example embodiments described above, and may be modified into various alternative embodiments without departing from the scope of the appended claims. The following alternative example embodiments are, for example, applicable.

### D1. First Alternative Example Embodiment

In the above example embodiments, the face of a person is employed as a subject with which the subject distance Sd is estimated (subject of a specific type); however, a selected subject other than the face of a person may be employed as a subject with which the subject distance Sd is estimated. For example, as far as a subject, such as a ball, a vehicle, a building, or a manufacturing equipment, that can be detected from a target image and the size of the subject is known, it may be employed as a subject with which the subject distance Sd is estimated. In addition, the method of detecting a subject from the target image may employ a selected method.

### D2. Second Alternative Example Embodiment

In the above example embodiments, a case in which only one face area FA is detected from the target image TI or the preliminary image is described; however, when a plurality of face areas FA are detected from the target image TI or the preliminary image, the subject distance Sd may be estimated for each of the face areas FA. When the subject distance Sd is estimated for the plurality of face areas FA, image processing, such as face shape correction process, may be executed on each of the face areas FA.

In addition, when the subject distance Ds is estimated for the plurality of face areas FA, the distance between the persons will be estimated. Various processes may be executed using the estimated distance between the persons. For example, it is possible to employ a condition that the estimated distance between the persons is equal to or smaller than a predetermined threshold value as an imaging condition in the third example embodiment. In addition, it is possible to use the estimated distance between the persons for generating a three-dimensional image.

### D3. Third Alternative Example Embodiment

In the above example embodiments, as shown in FIG. 8, the subject distance Sd is estimated using a horizontal length (the overall width Wwi of the target image TI, the width Wfi of the face area FA, the width Wf of the face of a person P, or the width Wx of the imaging plane IS); however, the subject distance Sd may be estimated using a vertical length, that is, the height of the target image TI, the height of the face area FA, the height of the face of a person P, or the height of the imaging plane IS.

In addition, in the above example embodiments, the overall width Wwi of the target image TI and the width Wfi of the face area FA are used as data by which the size of the image of a subject relative to the size of the target image TI is determined; however, the area of the face area FA (or the number of pixels) relative to the overall area (or the number of pixels) of the target image TI may be used instead.

### D4. Fourth Alternative Example Embodiment

In the third example embodiment, the image file that is generated in step S870 (FIG. 42) contains data that indicate the subject distance Sd that is estimated in step S830 (that is, data that indicate the subject distance Sd in the preliminary image). However, it is applicable that the subject distance Sd is newly estimated for an image generated through imaging in step S870 and then the image file contains data that indicate the newly estimated subject distance Sd.

In addition, in the first and second example embodiments, an image file that contains image data, on which face shape correction process and background blurring process have been executed, and data that indicate the subject distance Sd may be generated.

### D5. Fifth Alternative Example Embodiment

In the third example embodiment, the estimated subject distance Sd is used to set the focal range FR. That is, the subject distance Sd is used to help automatic focusing. However, it is possible to perform focusing in order to focus on the position of the estimated subject distance Sd. That is, without detecting the contrast, or the like, automatic focusing may be performed only using the subject distance Sd.

### D6. Sixth Alternative Example Embodiment

In the image generating process according to the third example embodiment, it is not necessary to determine the imaging timing on the basis of the subject distance Sd, and imaging may be instructed by user's operation instead. In addition, it is not necessary to set the focal range FR on the basis of the subject distance Sd, and general automatic focusing may be performed to search an optimal focal point within the maximum focal range FRmax instead.

In addition, in the third example embodiment, the subject distance Sd is used to determine whether imaging is performed by the DSC 500; however, the subject distance Sd may be used to determine whether recording is started by a dynamic image generating apparatus, such as a digital video camera.

### D7. Seventh Alternative Example Embodiment

In the above example embodiments, the deformation area is set as a rectangular area; however the shape of the deformation area may be another shape (for example, an elliptical shape or a rhombic shape).

### D8. Eighth Alternative Example Embodiment

In the above example embodiments, the face shape correction printing process (FIG. 3) by the printer 100, which serves as an image processing device, is described; however, the face shape correction printing process may be performed in such a manner that, for example, the face shape correction and the display of a corrected image (step S100 and step S200) are executed by a personal computer and only the printing process (step S300) is executed by the printer. In addition, the printer 100 is not limited to an ink jet printer, but may include printers of other types, such as a laser printer or a dye sublimation printer, for example.

In addition, the deformed image data may be not only used for printing but also used for a selected application. For example, a display device (for example, a projector) may be employed to use the image data for displaying.

### D9. Ninth Alternative Example Embodiment

In the above example embodiments, the deformation process may employ various processes. For example, the image in the deformation area TA may be not deformed in the height direction of the subject but only deformed in the horizontal direction of the subject.

In any cases as well, it is desirable to employ the deformation process in which the size of at least a portion of the subject on the target image TI in one direction (hereinafter, referred to as “reducing direction”) is reduced. In this manner, when the image and the actual subject are observed at an angle at which the reducing direction is oriented in a lateral direction as viewed from an observer, it is possible to approximate the impression of the subject obtained by observing the image to the impression obtained by observing the actual subject. Here, it is desirable to reduce the size shown by the contour of the subject in the reducing direction. That is, it is desirable that the length, in the reducing direction, of an area surrounded by the contour becomes small. In this manner, at least the contour of the subject is desirably deformed by the deformation process. In this manner, it is possible to appropriately approximate the impression of the subject obtained by observing the image to the impression obtained by observing the actual subject.

The reducing direction may be set in a selected direction on the target image TI. For example, a predetermined direction (for example, a direction parallel to the long side of the target image TI) may be employed as the reducing direction. However, it is desirable that an angle made by the reducing direction with the width direction of the subject is 30 degrees or below, it is particularly desirable that this angle is 15 degrees or below, and it is the most desirable that the reducing direction is oriented in the width direction of the subject. In this manner, in most cases, it is possible to execute natural and desirable deformation.

The method of determining the reducing direction so as to be approximated to the width direction of a subject may employ various methods. For example, the deformation processing unit may use information related to the width direction of a subject to thereby determine the reducing direction. The information related to the width direction of a subject may employ various pieces of information. For example, the detection result of the orientation of a subject may be employed. In the above described example embodiments, the face area detection unit 220 detects the orientation of a subject (in this case, a face) by analyzing the target image TI. In addition, some image pickup apparatuses store vertical information, which indicates a vertical direction (gravitational direction) with respect to the ground at the time of imaging, in an image file as history information. When such the vertical information is available, it is possible to specify the gravitational direction on the target image TI on the basis of the vertical information. Thus, it is possible to employ a direction perpendicular to that gravitational direction as the width direction of a subject.

In addition, the deformation processing unit may determine the reducing direction in accordance with instructions by a user. For example, the deformation processing unit may receive instructions that indicate the width direction of a subject and then determine the reducing direction in accordance with the received instructions.

In addition, there is a possibility that the width direction of a subject may be determined in advance to coincide with a predetermined direction on the target image TI. For example, in most target images TI which are imaged by a general user, the width direction of a subject is parallel to the long side of the target image TI. In such a case, the deformation processing unit may employ a predetermined direction (in this case, a direction parallel to the long side) on the target image TI as the width direction of a subject. That is, a predetermined direction on the target image TI may be employed as the reducing direction.

The above description may also apply to the case in which the subject is not the face of a person. In addition, a portion of the subject to be deformed may be selectively set.

### D10. Tenth Alternative Example Embodiment

In the above example embodiments a portion of configuration implemented by hardware may be replaced by software, or, conversely, a portion of configuration implemented by software may be replaced by hardware. For example, all the functions of the deformation area dividing unit 250 and the divided area deformation unit 260 shown in FIG. 1 may be implemented by a hardware circuit that includes a logic circuit.

On the other hand, when a portion or all of the functions of the aspects of the invention are implemented by software, the software (computer program) may be provided so that it is stored in a computer readable recording medium. A “computer readable recording medium” may not only be a portable recording medium, such as a flexible disk or a CD-ROM, but also an internal storage device of a computer, such as various RAMs or ROMs, and an external storage device, such as a hard disk, fixed to the computer.

### D11. Eleventh Alternative Example Embodiment

### Manner to Perform Deformation Process

To perform the deformation process, the image processing device that performs deformation of an image may include a deformation area setting unit that sets at least portion of an area on a target image as a deformation area, a deformation area dividing unit that arranges a plurality of dividing points in the deformation area and divides the deformation area into a plurality of small areas by using a straight line that connects the dividing points one another, and a deformation processing unit that moves at least one of positions of the dividing points to deform the small areas to thereby perform deformation of an image in the deformation area.

In this image processing device, a plurality of dividing points are arranged in a deformation area that is set on the target image, and the deformation area is divided into a plurality of small areas using a straight line that connects the dividing points one another. In addition, the deformation process of an image in the deformation area is executed in such a manner that the positions of the dividing points are moved and thereby the small areas are deformed. In this manner, in this image processing device, it is possible to perform image deformation only by arranging dividing points in the deformation area and then moving the arranged dividing points. Thus, it is possible to easily and effectively achieve image processing of image deformation corresponding to various deformation modes.

The above image processing device may further include a deformation mode setting unit that selects one of a plurality of predetermined deformation types and applies it to deformation of an image in the deformation area, wherein the deformation area dividing unit arranges the plurality of dividing points in accordance with a predetermined arrangement pattern that is associated with the set deformation type.

According to the above configuration, because the arrangement of dividing points, that is, dividing of the deformation area, appropriate to each of the deformation types, such as a deformation type to sharpen a face or a deformation type to enlarge eyes, for example, is performed, it is possible to further easily perform image processing for image deformation corresponding to each deformation type.

In addition, in the above image processing device, the deformation mode setting unit may select one of a plurality of predetermined deformation degrees and sets it as a deformation degree applied to deformation of an image in the deformation area, and the deformation processing unit may move positions of the dividing points in accordance with a predetermined moving direction and amount of movement that are associated with a combination of the set deformation type and deformation degree.

According to the above configuration, when the deformation type and the deformation degree are set, image deformation in accordance with the combination of them is executed. Thus, it is possible to further easily perform image processing for image deformation.

In addition, in the above image processing device, the deformation mode setting unit may include a specification acquiring unit that acquires user specification related to the moving direction and amount of movement of at least one of the dividing points, and the deformation processing unit may move a position of the at least one of the dividing points in accordance with the acquired user specification.

According to the above configuration, it is possible to easily achieve image processing for image deformation in a mode that is further close to user's request.

In addition, in the above image processing device, the deformation area setting unit may set the deformation area so as to include at least portion of an image of a face in the deformation area.

According to the above configuration, for the image of a face, it is possible to easily and effectively achieve image processing for image deformation corresponding to various deformation modes.

In addition, in the image processing device, the deformation area dividing unit may arrange the plurality of dividing points so that at least one pair of the dividing points are arranged at positions that are symmetrical with respect to a predetermined reference line, and the deformation processing unit may move the at least one pair of the dividing points while the positional relationship that the at least one pair of the dividing points are symmetrical with respect to the predetermined reference line is being maintained.

According to the above configuration, the image deformation that is bilaterally symmetrical with respect to a predetermined reference line is performed, so that it is possible to achieve image processing for image deformation of a further natural and desirable face image.

In addition, in the above image processing device, the deformation processing unit may be configured not to perform deformation on at least one of the small areas.

According to the above configuration, a desired image deformation may be performed without largely changing q the impression of a face, so that it is possible to achieve image processing for image deformation of a further natural and desirable face image.

In addition, in the above image processing device, the deformation processing unit may be configured not to perform deformation on the small area that includes the image of an eye.

According to the above configuration, by not performing deformation on the small area that includes the image of an eye, it is possible to achieve image processing for image deformation of a further natural and desirable face image.

In addition, the above image processing device may further include a face area detection unit that detects a face area that displays the image of a face on the target image, and the deformation area setting unit may set the deformation area on the basis of the detected face area.

According to the above configuration, with respect to image deformation of the deformation area that is set on the basis of the face area detected from the target image, it is possible to easily and effectively achieve image deformation corresponding to various deformation modes.

In addition, the image processing device may further include a printing unit that prints out the target image on which deformation of an image in the deformation area has been performed.

According to the above configuration, it is possible to easily and effectively achieve printing of an image on which image deformation has been performed in correspondence with various deformation modes.

What is claimed is:

1. An image processing method comprising:
acquiring first information that indicates a size of an image of a specific subject in a target image relative to a size of the target image;
acquiring second information that indicates a size of the specific subject;
acquiring third information with which an angle of view of the target image can be determined; and
estimating a subject distance, which is a distance from an image pickup apparatus that has generated the target image to the specific subject on the basis of the first information, the second information and the third information.

2. The image processing method according to claim 1, further comprising:
executing a specific process using the estimated subject distance.

3. The image processing method according to claim 2, wherein the execution of the specific process includes, as the specific process, executing image deformation within an area that includes the specific subject in the target image, and setting a deformation degree for the image deformation on the basis of the estimated subject distance so as to increase the deformation degree when the subject distance is small.

4. The image processing method according to claim 2, wherein the execution of the specific process includes, as the specific process, executing a blurring process on an image in a predetermined background area in the target image, and setting a blurring degree in the blurring process on the basis of the estimated subject distance so as to increase the blurring degree when the subject distance is small.

5. The image processing method according to claim 2, wherein the execution of the specific process includes, as the specific process, generating an image file that contains data indicating an image that includes the specific subject and data indicating the estimated subject distance.

6. The image processing method according to claim 2, further comprising:
generating an image through imaging, wherein
the execution of the specific process includes, as the specific process, setting a range, within which a focal point should be placed at the time of imaging of the specific subject in the generation of the image, to a range that is narrower than a maximum range, within which the focal point can be placed, on the basis of the estimated subject distance.

7. The image processing method according to claim 2, further comprising:
generating an image through imaging, wherein
the execution of the specific process includes, as the specific process, determining an imaging timing of the specific subject in the generation of the image on the basis of the estimated subject distance.

8. The image processing method according to claim 1, further comprising:
a subject detection unit that detects the image of the specific subject in the target image.

9. The image processing method according to claim 1, wherein the specific subject is a face of a person.

10. The image processing method according to claim 1, wherein the third information is information by which a relationship between the focal length of a lens at the time of imaging and the size of an imaging plane is determined.

11. An image processing device comprising:
a first information acquiring unit that acquires first information that indicates a size of an image of a specific subject in a target image relative to a size of the target image;
a second information acquiring unit that acquires second information that indicates a size of the specific subject;
a third information acquiring unit that acquires third information with which an angle of view of the target image can be determined; and
a subject distance estimation unit that estimates a subject distance, which is a distance from an image pickup apparatus that has generated the target image to the specific subject on the basis of the first information, the second information and the third information.

12. A computer readable storage medium storing a computer program for image processing, the computer program comprising instructions for:
acquiring first information that indicates a size of an image of a specific subject in a target image relative to a size of the target image;
acquiring second information that indicates a size of the specific subject;
acquiring third information with which an angle of view of the target image can be determined; and
estimating a subject distance, which is a distance from an image pickup apparatus that has generated the target image to the specific subject on the basis of the first information, the second information and the third information.
